(19) United States
(12) Patent Application Publication
(10) Pub. No.: US 2016/0381118 A1
(43) Pub. Date: Dec. 29, 2016

(54) EXTRACTING AND FORMATTING CONTENT FROM WEB-RESOURCES

(71) Applicant: Microsoft Technology Licensing, LLC, Redmond, WA (US)

(72) Inventors: Anthony Andrews, Bellevue, WA (US); Ali Alvi, Kirkland, WA (US); Adrian Dumitrascu, Redmond, WA (US); Yuan-Chun Chiu, Redmond, WA (US); Ji Jeong Kang, Seattle, WA (US); William Shelor, Seattle, WA (US); Scott Hanselman, Forest Grove, OR (US)

(21) Appl. No.: 14/874,059

(22) Filed: Oct. 2, 2015

Related U.S. Application Data
(60) Provisional application No. 62/183,626, filed on Jun. 23, 2015.

(51) Int. Cl. H04L 29/08

(52) U.S. Cl. CPC H04L 67/06; H04L 67/02

(57) ABSTRACT

A system is provided for presenting content on a companion computing device associated with a primary computing device. A web-resource micro-app package is configured, when operating in concert with a companion manager executing on the primary computing device, to control the delivery and presentation of content on the companion computing device. The web-resource micro-app package is cross-platform and thus operable, without modification, with any of a number of different operating systems with which the companion manager and primary computing device might be associated. The web-resource micro-app package includes a location of a web-resource, identification of predetermined content items to be extracted from the web-resource, and presentation parameters for formatting a content group including at least some of the predetermined content items for presentation on the companion computing device.

### CROSS REFERENCE TO RELATED APPLICATIONS

This application claims priority to U.S. Provisional Patent Application No. 62/183,626, filed Jun. 23, 2015, and titled “WEB-RESOURCE DATA EXTRACTION AND FORMATTING SYSTEMS” the entirety of which is hereby incorporated herein by reference.

### BACKGROUND

A web-based content developer may need to present information so that it may be accessible by end-users of different computing devices. A single end-user may desire to view different subsets of the content on multiple devices utilizing different operating systems and featuring a variety of display types.

### BRIEF DESCRIPTION OF THE DRAWINGS

FIGS. 1A and 1B depict an example wearable sensory-and-logic device.

FIG. 2 depicts an example system for presenting content on a companion computing device.

FIG. 3 depicts an example web-resource micro-app package.

FIG. 4 depicts example layouts for content presentation via a web-resource micro-app.

FIG. 5 depicts a flowchart for an example method for installing a web-resource micro-app package at a primary computing device.

FIG. 6 depicts a flowchart for an additional example method for installing a web-resource micro-app package at a primary computing device using a cloud computing service.

FIG. 7 depicts a flowchart for an example method for updating content on a web-resource micro-app.

FIG. 8 depicts a flowchart for an additional example method for updating content on a web-resource micro-app using a cloud computing service.

FIG. 9 depicts a flowchart for an example method for presenting content received from a 3^{rd} party push service on a web-resource micro-app.

FIG. 10 depicts an example computing system that may be used to discover, install, and manage web-resource micro-apps.

### DETAILED DESCRIPTION

Smart phones, and other mobile computing devices, can be operated on multiple platforms or operating systems. In order to distribute content to all potential consumers, applications are typically generated which are natively operable on each platform. A content provider must thus create, author, update, and maintain applications for each mobile operating system. The advent of smart-watches and other companion mobile computing devices, such as head mounted displays and computing devices, and other wearable computing devices which may communicate with or via a user's primary mobile computing device, adds additional complexity for content developers, as corresponding companion applications may need to be developed for each combination of mobile device and companion device. Each natively operating application must further be maintained and updated for each upgrade to each mobile operating system, upgrades to each companion device operating system, and for each new version of either the primary or companion devices. This is both cost- and time-prohibitive for many small content developers, particularly for providing content to wrist-worn computing devices which can only display a modest amount of information at one time.

The present description contemplates a companion manager or host-application that operates natively on a mobile phone (or other computing device) for each user of a specific smartwatch, in order to facilitate operation of the smartwatch and communication between the two devices. For example, the companion manager may be a health-related app which is configured to receive and process health-related data derived from sensors within the smartwatch, and to output refined health-related information to the smartwatch that can be interpreted by an end-user at a glance. In such an example, the health-related app, the mobile phone and associated smartwatch may be specific to a mobile operating system (e.g., iOS). However, some smartwatches are cross-platform compatible. This typically requires each smartwatch developer to create different versions of the companion manager, each of which can operate natively on a mobile operating system. Thus, the architecture of each companion manager must intrinsically facilitate communication in a fashion that is specific for the smartwatch and mobile operating system. A content provider may be able to exploit this architecture by providing instructions executable by the companion manager for retrieving and extracting content from a web-resource, and for formatting that content for consumption on the companion device.

As an example, a developer may generate a web-resource micro-app package enabling for the presentation of content on companion computing devices without requiring the coding and development of applications which execute natively on each mobile operating system. The web-resource micro-app package is a software object that is hosted within the companion manager on a primary computing device. The web-resource micro-app package provides instructions to the companion manager regarding the location of a web-resource, predetermined content items to be extracted from the web-resource, and formatting parameters by which the content is to be presented on the companion computing device. The companion manager then accesses the web-resource, extracts the content of interest, formats the extracted content, and delivers the formatted content to the companion computing device in the form of a micro-app. In this way, content may be delivered to the companion computing device from virtually any data source on the web, while developers will only have to write code once to support multiple mobile platforms, as the companion manager will provide the required native support.

In the context of the above example, such a web-resource micro-app package could be an object that instructs the companion manager to retrieve and extract an end-user's blood sugar data from a cloud-based web-resource and format it in a particular way that is suited aesthetically to the smartwatch and that accounts for its small display. Other related health data may be combined with the blood-sugar data for presentation as a single micro-app. Data may be retrieved from a single web-resource, multiple web-resources, from data stored on the end-user's mobile phone, from data collected by the smart-watch, etc.

Assembling a web-resource micro-app package may be such that a content provider or end-user that has little to no expertise in software development can choose which data to present, how they want the data to appear, etc. As the instructions within a web-resource micro-app package are completely independent of operating system, there is no repetitive expense or effort to generate a micro-app that works for all operating systems. A user switching mobile phones or smartwatches while maintaining the companion manager may simply re-install the web-resource micro-app package and expect it to work seamlessly in the new computing environment. By drastically reducing the investment required to present content on companion computing devices, content provider and developer interest, as well as customer engagement may be increased.

Herein, a smart-phone will primarily be used as an example of a primary computing device, while a smart-watch or wrist-worn electronic device will primarily be used as an example of a companion computing device. However, it should be understood that other computing devices may be used as either primary or companion computing devices, and that the mobility of a computing device is not a requirement for the systems and methods described herein.

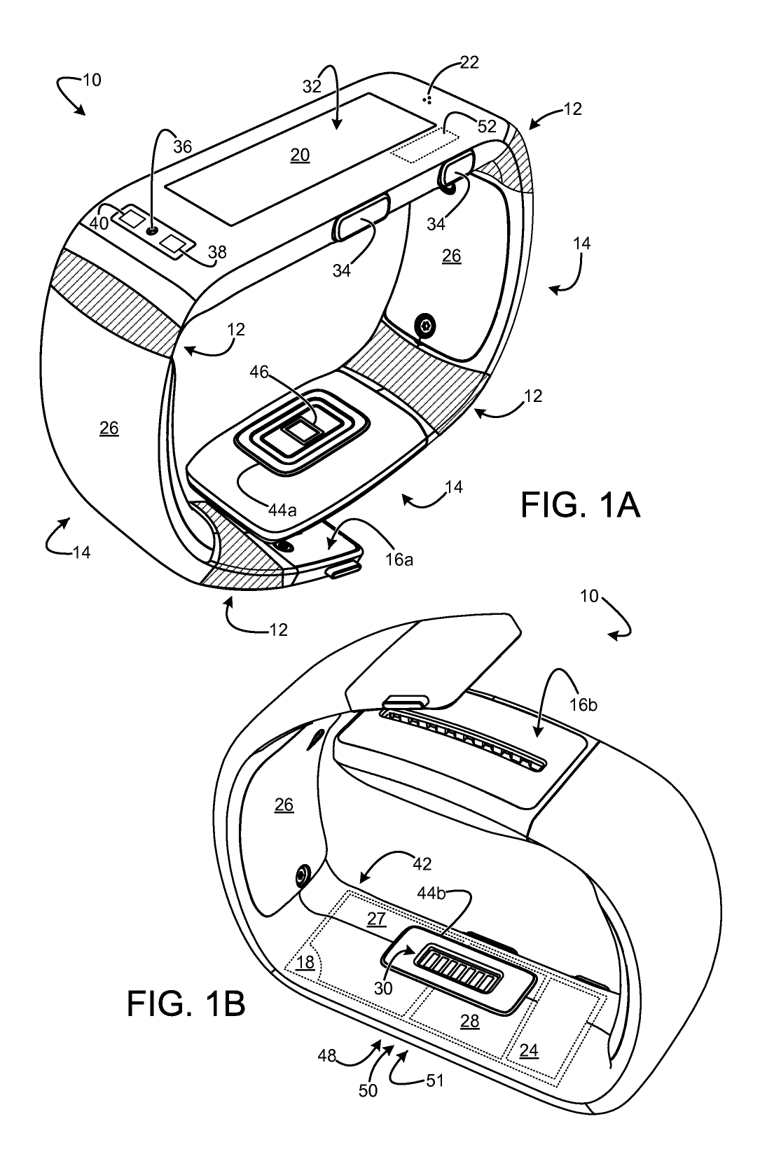

FIGS. 1A and 1B show aspects of an example sensory-and-logic system in the form of a wearable electronic device 10. Wearable electronic device 10 is an exemplary companion computing device which may be operated in conjunction with an associated primary computing device, such as a smart-phone, tablet computing device, gaming device, or other mobile or desktop computing device. The illustrated device is band-shaped and may be worn around a wearer's wrist. Wearable electronic device 10 includes at least four flexion regions 12 linking less flexible regions 14. The flexion regions 12 of wearable electronic device 10 may be elastomeric in some examples. Fastening componentry 16A and 16B is arranged at both ends of wearable electronic device 10. The flexion regions 12 and fastening componentry 16A and 16B enable wearable electronic device 10 to be closed into a loop and to be worn on a wearer's wrist. In other implementations, a sensory-and-logic system may be implemented in the form of wearable electronic devices having a more elongate band shape which may be worn around a wearer's bicep, waist, chest, ankle, leg, head, or other body part. Such a wearable electronic device, for example, may take the form of eye glasses, a head band, an arm-band, an ankle band, a chest strap, or an implantable device to be implanted in tissue.

Wearable electronic device 10 includes various functional components integrated into flexible regions 14. In particular, wearable electronic device 10 includes a compute system 18, display 20, loudspeaker 22, communication suite 24, and various sensors. These components draw power from one or more energy-storage cells 26. A battery—e.g., a lithium ion battery—is one type of energy-storage cell suitable for this purpose. Examples of alternative energy-storage cells include super- and ultra-capacitors. In examples where wearable electronic device 10 is configured to be worn on a wearer's wrist, energy-storage cells 26 may be curved to fit the wrist, as shown in the drawings.

In general, energy-storage cells 26 may be replaceable and/or rechargeable. In some examples, recharge power may be provided through a universal serial bus (USB) port 30, which includes a magnetic latch to releasably secure a complementary USB connector. In other examples, energy-storage cells 26 may be recharged by wireless inductive or ambient-light charging. In still other examples, wearable electronic device 10 may include electro-mechanical componentry to recharge the energy storage cells from the user's adventitious or purposeful body motion. For example, batteries or capacitors may be charged via an electromechanical generator integrated into wearable electronic device 10. The generator may be turned by a mechanical armature that turns while the wearer is moving and wearing wearable electronic device 10.

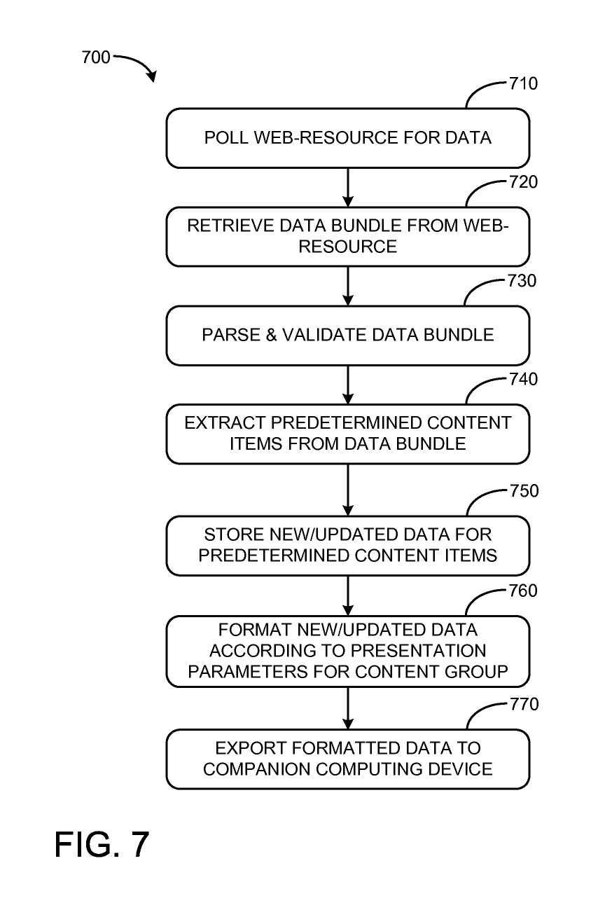

In wearable electronic device 10, compute system 18 is situated below display 20 and operatively coupled to display 20, along with loudspeaker 22, communication suite 24, and the various sensors. Compute system 18 includes a data-storage machine 27 to hold data and instructions, and a logic machine 28 to execute the instructions. Aspects of compute system 18 are described in further detail with reference to FIG. 7.

Display 20 may be any suitable type of display. In some configurations, a thin, low-power light emitting diode (LED) array or a liquid-crystal display (LCD) array may be used. An LCD array may be backlit in some implementations. In other implementations, a reflective LCD array (e.g., a liquid crystal on silicon, LCOS array) may be frontlit via ambient light. A curved display may also be used. Further, active matrix organic LED (AMOLED) displays or quantum dot displays may be used.

Communication suite 24 may include any appropriate wired or wireless communications componentry. In FIGS. 1A and 1B, communication suite 24 includes USB port 30, which may be used for exchanging data between wearable electronic device 10 and other computer systems, as well as providing recharge power. Communication suite 24 may further include two-way Bluetooth, Wi-Fi, cellular, near-field communication and/or other radios. In some implementations, communication suite 24 may include an additional transceiver for optical, line-of-sight (e.g., infrared) communication.

In wearable electronic device 10, touch-screen sensor 32 is coupled to display 20 and configured to receive touch input from the wearer. Touch-screen sensor 32 may be resistive, capacitive, or optically based. Pushbutton sensors may be used to detect the state of push buttons 34, which may include rockers. Input from the pushbutton sensors may be used to enact a home-key or on-off feature, control audio volume, turn microphone 36 on or off, etc.

FIGS. 1A and 1B show various other sensors of wearable electronic device 10. Such sensors include microphone 36, visible-light sensor 38, ultraviolet sensor 40, and ambient temperature sensor 42. Microphone 36 provides input to compute system 18 that may be used to measure the ambient sound level or receive voice commands from the wearer. Input from visible-light sensor 38, ultraviolet sensor 40, and ambient temperature sensor 42 may be used to assess aspects of the wearer's environment—i.e., the temperature, overall lighting level, and whether the wearer is indoors or outdoors.

FIGS. 1A and 1B show a pair of contact sensor modules 44A and 44B, which contact the wearer's skin when wearable electronic device 10 is worn. Contact sensor modules 44A and 44B may include independent or cooperating sensor elements, to provide a plurality of sensory functions. For example, contact sensor modules 44A and 44B may provide an electrical resistance and/or capacitance sensory function, which measures the electrical resistance and/or capacitance of the wearer's skin. Compute system 18 may use such input to assess whether or not wearable electronic device 10 is being worn, for instance. In some implementations, the sensory function may be used to determine how tightly wearable electronic device 10 is being worn. In the illustrated configuration, the separation between contact-sensor modules 44A and 44B provides a relatively long electrical path length, for more accurate measurement of skin resistance. In some examples, one or both of contact sensor modules 44A and 44B or an additional contact sensor module may provide measurement of the wearer's skin temperature. Arranged inside contact sensor module 44B in the illustrated configuration is optical heart rate sensor 46. The optical heart rate sensor may include an optical source and matched optical sensor to detect blood flow through the capillaries in the skin and thereby provide a measurement of the wearer's heart rate, blood oxygen level, blood glucose level, or other biomarkers with optical properties.

Wearable electronic device 10 may also include motion sensing componentry, such as an accelerometer 48, gyroscope 50, and magnetometer 51. Accelerometer 48 and gyroscope 50 may furnish inertial and/or rotation rate data along three orthogonal axes as well as rotational data about the three axes, for a combined six degrees of freedom. This sensory data can be used to provide a pedometer/calorie-counting function, for example. Data from accelerometer 48 and gyroscope 50 may be combined with geomagnetic data from magnetometer 51 to further define the inertial and rotational data in terms of geographic orientation. Wearable electronic device 10 may also include a global positioning system (GPS) receiver 52 for determining the wearer's geographic location and/or velocity. In some configurations, the antenna of GPS receiver 52 may be relatively flexible and may extend into flexion regions 12.

Compute system 18, via the sensory functions described herein, is configured to acquire various forms of information about the wearer of wearable electronic device 10. Such information must be acquired and used with utmost respect for the wearer's privacy. Accordingly, the sensory functions may be enacted subject to opt-in participation of the wearer. In implementations where personal data is collected on wearable electronic device 10 and transmitted to a remote system for processing, that data may be anonymized. In other examples, personal data may be confined to wearable electronic device 10, and only non-personal, summary data transmitted to the remote system.

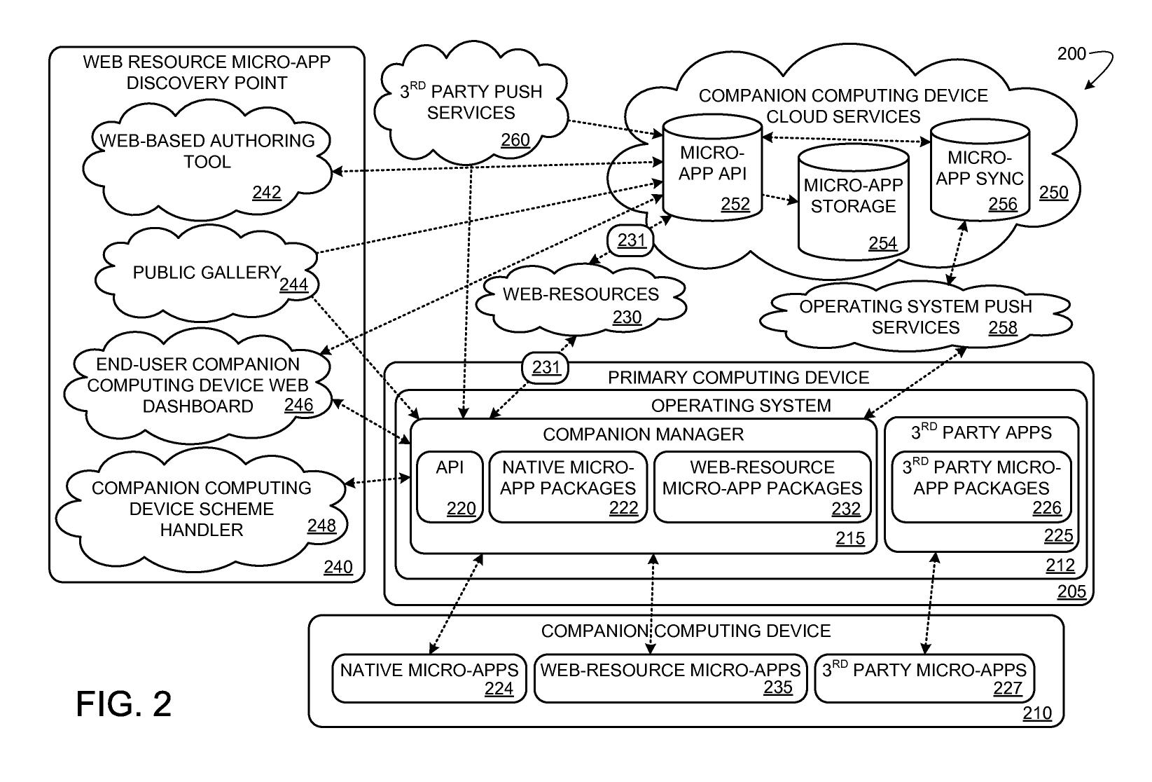

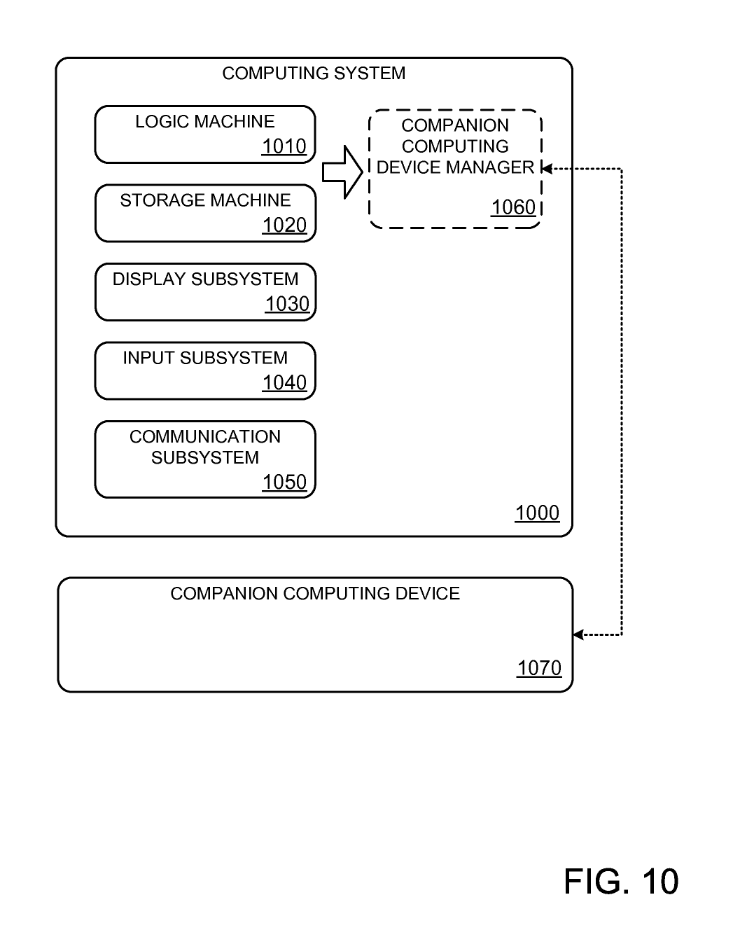

FIG. 2 shows an example system 200 for presenting content on a companion computing device, such as wearable electronic device 10. System 200 includes a primary computing device 205 associated with a companion computing device 210. An example primary computing device is explained in detail with reference to FIG. 10. Briefly, primary computing device 205 may take the form of one or more personal computers, server computers, tablet computers, home-entertainment computers, network computing devices, gaming devices, mobile computing devices, mobile communication devices (e.g., smart phone), and/or other computing devices, and may include a storage machine, a logic machine, a display subsystem, an input subsystem, a communication subsystem, and/or other components. Similarly, companion computing device 210 may take the form of any of the aforementioned devices, and may include a storage machine, a logic machine, a display subsystem, an input subsystem, a communication subsystem, and/or other components.

Primary computing device 205 may include an operating system 212. Operating system 212 may provide a platform for a logic machine and/or one or more processors configured to execute software instructions on primary computing device 205. The platform provided by operating system 212 may indicate to primary computing device 205 how to execute instructions that are part of one or more applications, services, programs, routines, libraries, objects, components, data structures, or other logical constructs. Operating system 212 may be configured to translate and implement instructions provided in a programming language or set of languages. As such, different operating systems may be configured to translate different sets or types of instructions for execution on the respective primary computing device. A set of instructions for an application, for example, may need to be specifically coded to be readable by a particular operating system. For example, a developer wishing to provide an application across multiple mobile operating systems (e.g., Windows Phone™, Android™, iOS™) may need to code separate versions of the application for each mobile operating system.

Primary computing device 205 may be associated with companion computing device 210 via a companion manager 215 configured to execute on primary computing device 205. Companion manager 215 may be configured so as to execute in concert with operating system 212, and companion manager 215 may not be configured to execute in concert with other operating systems. In other words, companion manager 215 is operating system-specific. To work with other operating systems, alternate versions must be designed, often from the ground up and at considerable expense. Companion manager 215 may facilitate communication between primary computing device 205 and secondary computing device 210, and thus may facilitate syncing of the two devices, data transfer between the two devices, etc.

Companion manager 215 may facilitate operation of companion computing device 210 via application programming interface (API) 220. For example, API 220 may take advantage of processor speed, memory, data-storage, power, and/or other aspects of primary computing device 205 in order to reduce the amount of computing effort performed at companion computing device 210, thus increasing the capabilities of companion computing device 210.

Companion manager 215 may include a set of native micro-app packages 222. Native micro-app packages 222 may include instructions executable by companion manager 215 for retrieving and formatting content for native micro-apps 224 executing on companion computing device 210. Each native micro-app package may include instructions written in a programming language such that they are natively executable on operating system 212. Each native micro-app may represent media items, applications, contacts, settings, or virtually any other computing object operable via the user interface (UI) for companion computing device 210.

As an example, for a companion computing device such as wearable electronic device 10, a native health-related micro-app may present information regarding an end-user's heart rate, blood pressure, and calories expended over time. The corresponding native micro-app package may provide instructions to companion manager 215 to (1) retrieve data from companion computing device sensors, data stored on primary computing device 205, and/or data retrieved from one or more web-resources or peripheral computing devices; (2) process the retrieved data; (3) format the retrieved data for presentation on the display of wearable electronic device 10; and (4) export instructions to wearable electronic device 10 to present the formatted data via a native micro-app.

Primary computing device 205 may further include a set of 3^{rd} party apps (applications) 225. A 3^{rd} party app, as used herein, is a computing object that executes natively on operating system 212, and that is authored, serviced, and maintained by a 3^{rd} party developer (e.g., different from the developer of companion manager 215, operating system 212, or primary computing device 205). Each 3^{rd} party app 225 may have a user interface to a service for an end-user of primary computing device 205. For example, each 3^{rd} party app provider may include a server to manage the particular service for deployment to the various different end-user computing devices. Each 3^{rd} party app provider may provide content for devices that have different operating systems. Each device may be configured to receive a particular type of message from the server computing system, which other computing devices may not be configured to process. As such, each server computing system associated with a 3^{rd} party app may output messages which include similar content, but are formatted or transferred via a protocol that is specific to each operating system executing the 3^{rd} party app.

3^{rd} party app providers may distribute 3^{rd} party micro-app packages 226 for end-users to install a 3^{rd} party micro-app 227 on companion computing device 210. 3^{rd} party micro-app 227 may present a subset of the content available through 3^{rd} party app via companion computing device 210. 3^{rd} party micro-app package 226 may be installed on primary computing device 205 as an update to 3^{rd} party app 225. In some examples, 3^{rd} party micro-app package 226 may only be installed on primary computing devices associated with a companion computing device and/or may be installed responsive to a request from an end-user indicating to install 3^{rd} party micro-app 227 on companion computing device 210.

A 3^{rd} party micro-app package 226 may provide instructions for retrieving a subset of data via 3^{rd} party app 225, and formatting and exporting the subset of data to corresponding 3^{rd} party micro-app 227 for presentation on companion computing device 210. For example, a basketball-related 3^{rd} party app 225 may have a 3^{rd} party micro-app 227 for providing score updates for an end-user's favorite basketball team. As an example, 3^{rd} party micro-app package 226 can provide instructions relating to (1) the identity of the basketball team, (2) a frequency with which to provide updates to 3^{rd} party micro-app 227, and (3) a subset of player/team statistics for display on companion device 210. 3^{rd} party app 225 may execute the provided instructions, collect the specified data, and format the data for export to 3^{rd} party micro-app 227. 3^{rd} party micro-app 227 may then provide in-game updates for the end-user's favorite team that include a game score, time remaining, and other specified statistics on companion device 210 at the specified frequency. In some examples, notifications could be conditionally provided via companion computing device 210, such as a game beginning or ending, a lead change, etc.

However, as 3^{rd} party apps 225 and 3^{rd} party micro-app packages 226 must be configured for operating system 212, a content provider desiring to provide a cross-platform 3^{rd} party micro-app 227 for companion computing device 210 thus must develop, debug, and update a 3^{rd} party micro-app package that is specific for each native version of the 3^{rd} party app. This represents a significant barrier for many content providers, as well as end-users desiring to select content from one or more web-resources 230 for presentation on companion computing device 210.

To address this problem, web-resource micro-app packages 232 may be installed on primary computing device 205. A web-resource micro-app package may, when operating in concert with companion manager 215, control the delivery and presentation of content from one or more web-resources 230 on companion device 210. In many cases, web-resource micro-app packages 232 are cross-platform and thus operable, without modification, with any of a number of different operating systems with which the companion manager 215 and primary computing device 205 might be associated.

Installation of a web-resource micro-app package 232 on primary computing device 205 may enable installation of a web-resource micro-app 235 on companion computing device 210. This allows an end-user to receive content from web-resources at companion computing device 210 without the need for a micro-app package that executes natively on operating system 212. Companion manager 215 may include a web-resource micro-app management module (not shown). The web-resource micro-app management module may be installed by the manufacturer of primary computing device 205, via a software update to operating system 212 and/or companion manager 215, or responsive to an end-user request via primary computing device 205 or companion computing device 210.

A web-resource micro-app package 232 may provide instructions to companion manager 215, which may be communicatively coupled to web-resources 230. Companion manager 215 may then (1) access web-resources 230, retrieve a data bundle 231 from the web-resource 230; (3) extract predetermined content items from the data bundle 231, (4) format the predetermined content items for presentation on companion computing device 210, and (5) export the formatted content items to companion computing device 210 via web-resource micro-app 235. As an example, a diabetic end-user may upload personal health data including blood sugar levels, timing and volume of insulin injections, a diet log, etc. to a health management website. Web-resource micro-app package 232 may provide (1) instructions as to the location of the health management website, (2) information for retrieving and extracting specific personal health data from the health management website, and (3) formatting parameters to display the extracted specific personal health data on companion computing device 210.

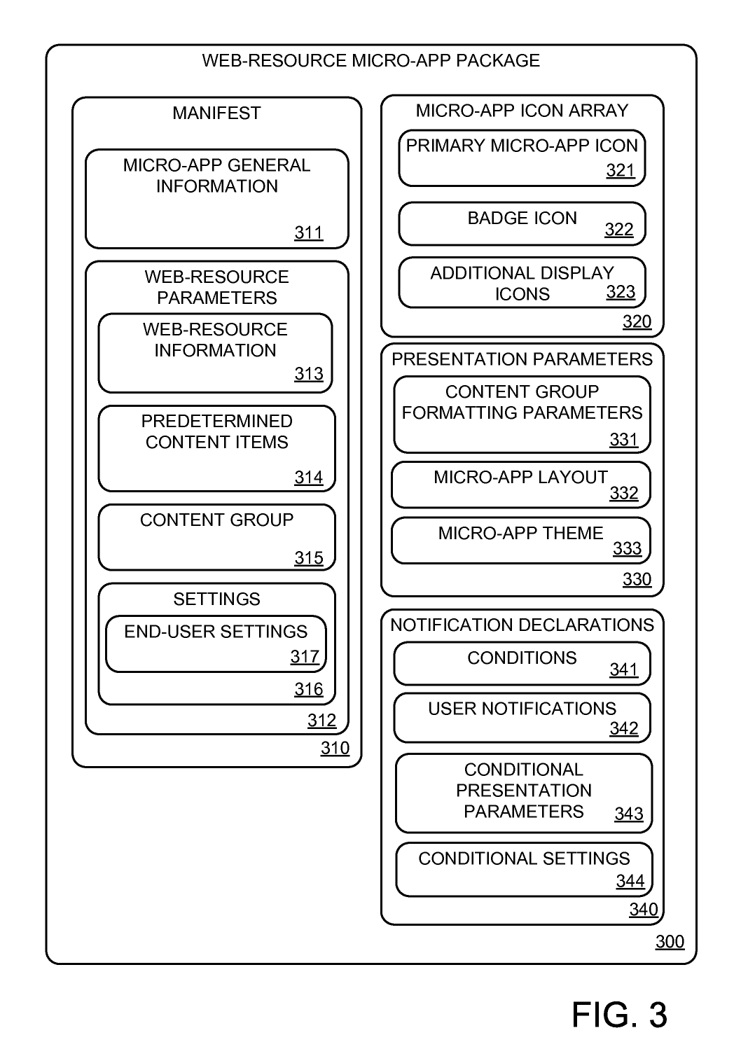

Turning to FIG. 3, an example web-resource micro-app package 300 is depicted. Web-resource micro-app package 300 may be a collection of files, data, and information that are readable by companion manager 215. Web-resource micro-app package 300 may include, for example: (1) a location of a web-resource, (2) identification of predetermined content items to be extracted from the web-resource, and (3) presentation parameters for formatting a content group including at least some of the predetermined content items for presentation on a companion computing device. Web-resource micro-app package 300 may indicate locations of the predetermined content items within data bundles 231 retrieved from the web-resource data feed. Web-resource micro-app package 300 may further include icons to be presented on the companion computing device and presentation parameters for displaying at least one icon on the companion computing device along with a formatted content group.

Web-resource micro-app package 300 may also include one or more notification declarations for the content group, each notification declaration comprising a condition for the content group, and a user notification to be issued by the companion computing device responsive to the condition being met. Web-resource micro-app package 300 may further include one or more authentication factors required to access and/or translate an encrypted web-resource. One or more end-user settings may be included that are adjustable by an end-user of the companion computing device to modify a parameter of the web-resource micro-app. Web-resource micro-app package 300 may also indicate metadata associated with a web-resource micro-app to be installed on companion computing device 210.

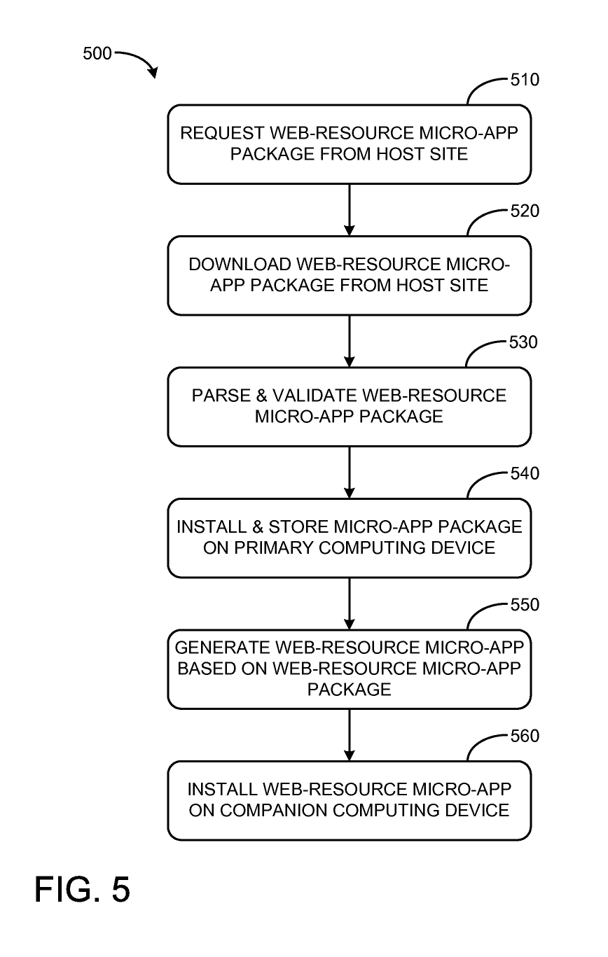

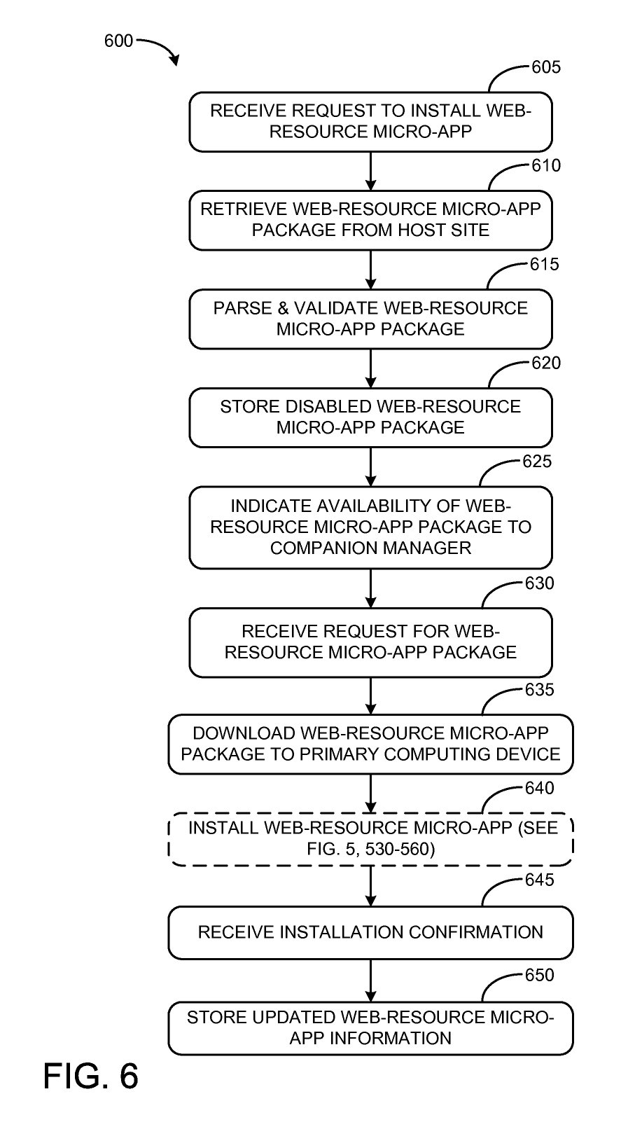

Developers may generate a web-resource micro-app package using templates or guidelines provided by the developers of the companion manager 215, and may author the web-resource micro-app package using standard text editors and file utilities, and/or authoring tools, described in further detail herein. Web-resource micro-app package 300 may include a collection of files created using the standard “zip” format (e.g., a package archive), and may be given a standardized file format extension that can be recognized by companion manager 215. Companion manager 215 may be registered as the handler for such an extension, so that a web-resource micro-app package downloaded to primary computing device 205 may automatically trigger an installation workflow. Installation workflows are described further herein and with reference to FIGS. 5 and 6. The web-resource micro-app package files may be coded in standardized formats, such as XML, JSON, and HTML, and may allow for updates to be applied as new micro-app formats, data options, and/or user interactions become available.

Web-resource micro-app package 300 includes manifest 310 which includes general information pertaining to the micro-app, and parameters pertaining to the web-resource(s) which will supply data to be presented with the micro-app. Manifest 310 may live in the root of a package archive, and may contain references to the other assets contained in the package archive. As a non-limiting example, manifest 310 may be formatted as a single JavaScript Object Notation (JSON) object, for example. JSON objects may include a collection of name/value pairs as well as an ordered list of values. However, any suitable data-interchange format may be used for manifest 310 and/or the files and objects contained therein. Manifest 310 may contain a variety of information used by companion manager 215 to install and operate web-resource micro-app package 300 on primary computing device 205, and to install and operate a web-resource micro-app on companion computing device 210.

Manifest 310 includes micro-app general information 311 and web-resource parameters 312. Micro-app general information 311 includes information about the web-resource micro-app package and developer. Micro-app general information 311 may include a manifest version. The manifest version may define the contract between the web-resource micro-app developer and the companion manager, allowing for future changes to the manifest contents. For the initial release, the manifest version may be given a value of 1. Updates to the manifest within a contract duration may be given decimal values (1.1, 1.2, etc.) while new contracts may be given increased integer values (2.0). The manifest version may indicate to the companion manager whether the web-resource micro-app package is authorized for installation and use on the primary computing device.

Micro-app general information 311 may include a (short) web-resource micro-app name. This name may be used in the micro-app user experience (UX) of the companion manager and in a public web-resource micro-app gallery. Micro-app general information 311 may further include a description. The description may be used in the web-resource micro-app gallery or in other settings where detailed information about the web-resource micro-app is shown.

Micro-app general information 311 may include a web-resource micro-app version number. The version number may be a numeric field that specifies the version number of the web-resource micro-app. It may contain a positive integer that is incremented whenever a new version of the micro-app is created. When a web-resource micro-app package is installed, the location from which it was obtained is stored along with the contents of the web-resource micro-app package so that updates can be detected. If a web-resource micro-app version number is not provided, updates may not be automatically detected. Micro-app general information 311 may further include a web-resource micro-app version string, which may be a user-friendly form of the version number, such as a descriptive name or condensed numeric identifier. If present, the web-resource micro-app version string may be used when displaying version information. If the version string is absent, the version number may be shown. If neither is provided, no version information will be shown.

Micro-app general information 311 may further include an author meta-file and/or an organization meta-file, indicating the name of any individuals or groups that were involved in the authoring of web-resource micro-app package 300. The author and/or organization information may be presented wherever detailed information pertaining to the web-resource micro-app is shown. Micro-app general information 311 may further include a contact email meta-file, which may provide an email address for the web-resource micro-app package author. The email address may be used for administrative purposes and analytics.

Web-resource parameters 312 may include web-resource information 313. Web-resource information 313 may include one or more web-resource description objects which enumerate the web-resources that provide content for the web-resource micro-app. For each web-resource, a description object may indicate the location of the web-resource. For example, the location may include a URL to be referenced. The location may further include string substitutions to provide path elements or query parameters that influence the content to be returned based on end-user settings.

Web-resource information 313 may include a web-resource type, for example “simple” or “feed”. As an example, a simple web-resource may output and update each data bundle 231 individually, while a feed web-resource may output and update up to 8 data bundles 231 with the same layout and different date concurrently (e.g., ATOM or RSS feeds).

Web-resource parameters 312 further include the identity and location of predetermined content items 314 within a web-resource data bundle. In other words, web-resource parameters 312 include information for extracting specific content items 314 from a data bundle 231 retrieved from a web-resource 230. The predetermined content items 314 may consist of an object in which each content item name defines a “variable” in the data bundle, and a content item value is an expression (e.g. xpath) describing where the content item can be found in the data bundle. The content item value may be interpreted according to the content type of the data bundle. For XML content, the content item value may be an xpath. For JSON content, the content item value may be a simplified JavaScript object expression. Content item variables may be created and bound to fields within the first element of an array in a JSON data bundle 231 object. These variables may be used later in text bindings to supply content to the web-resource micro-app 235.

Web-resource parameters 312 may further include the identities of content group 315 which may be collectively presented in a web-resource micro-app 235. Content group 315 may include predetermined content items 314 from a single web-resource 230 or from multiple web-resources 230. In some examples, content group 315 may include static members, such as a title, end-user name, or descriptor, and/or other non-web-resource members, such as a current time, date, and/or other information that may be retrieved from primary computing device 205 or any other data source.

Web-resource parameters 312 further include settings 316, which may include one or more end-user settings 317. Each setting 316 may include one or more setting definitions. A setting definition may include: (1) a name, used to refer to the current setting value; (2) a title, or short name for the setting, for use in the companion manager UI; (3) a summary or longer description of the setting, also for use in the UI; and (4) a type, among other information. The type definition may specify the type of the setting data (e.g., text, list, number, Boolean) The UX code may use this to dynamically generate a settings UI which allows the end-user to view and/or adjust settings values via the companion manager or at the companion device.

A setting definition may further include a subtype, which may be used to specify the kind of text that is permitted so a suitable keyboard can be presented. A setting definition may include a default value for the setting. During installation, if an end-user setting has a default value that is Null, the end-user may be prompted to enter a real value for the setting prior to completing installation. If all end-user settings 317 have default values, then the settings may not be shown to the end-user during micro-app installation. Each setting definition may further include one or more entries, each entry including an array of list elements. As an example, each element may be a 2-element array containing, the displayable list item followed by the corresponding internal value.

Settings 316 may include parameters for retrieving data from web-resources 230. For example, if multiple dependent web-resources 230 are provided, and there are any indicated dependencies between them (e.g., content from one URL is referenced in the “url” or “content” properties of another resource) they may be processed in the order in which they are indicated in manifest 310. If there are no such dependencies, companion manager 215 may request data bundles 231 from multiple web-resources 230 concurrently.

Settings 316 may include a refresh interval meta-file which may specify the preferred refresh interval for the web-resource micro-app (e.g., in minutes). If present, the refresh interval may be a positive integer value. Companion manager 215 may make a best effort, depending on available resources, to refresh web-resource micro-app 235 at the desired rate. This may include requesting data bundles 231 from web-resources 230 at a rate which allows retrieved data to be processed and formatted within the refresh interval. As such, the data bundle 231 request rate may thus be based on a quality and magnitude of a network connection between companion manager 215 and web-resources 230. Settings 316 may include processing rules meta-files which indicate parameters for processing data bundles 231 retrieved from different types of web-resources 230.

For example, web-resource micro-apps 235 using web-resource feeds may be limited by a set of rules within settings 316. For example, any pages or data bundles 231 following the first data bundle 231 retrieved may be ignored. The specified web-resources 230 for a given web-resource micro-app 235 may not be allowed to contain more than one feed-style resource. Presentation parameters may be limited, such as only allowing a title and icon to be presented. Data bundles 231 retrieved from feeds may also be handled with a set of rules. For example, a specified number of recent content items 314 may be extracted from the feed (e.g., 8). Each content item 314 may be extracted using the binding information provided in manifest 310, and each content item 314 treated as the document root for purposes of data extraction. Any duplicate content items 314 may be filtered prior to formatting a content group 315 for presentation on companion computing device 210.

End-user settings 317 may allow web-resource micro-app developers to generalize their web-resource micro-apps 235 by allowing end-users to customize the behavior of web-resource micro-app 235 in well-defined ways. The developer may empower the end-user to make customizable choices, such as setting a location to receive weather and other pertinent localized information, customizing colors or fonts for a web-resource micro-app 235, etc. In some examples, end-user settings 317 may allow an end-user to adjust the web-resources 230, predetermined content items 314, and/or content group 315 for a web-resource micro-app 235. For example, for a ‘News’ web-resource micro-app, end-users could customize the URLs from which the data bundles 231 are retrieved, specify keywords or classifications of stories to extract, and/or specify specific content items 314 to bundle within a content group 315.

End-user settings 317 may be dynamic, allowing web-resource micro-apps 235 to draw dynamic information from two sources—end-user settings 317 and web-resources 230. Name bindings may be created for each of these so that their current values can be referenced, as appropriate, within manifest 310. The declaration of each setting value in manifest 310 may specify a setting name. Similarly, the web-resource parameters 312 in manifest 310 may describe how to extract the predetermined content items 314 from a data bundle, and may assign names to each content item 314. A substitution mechanism may be provided to allow dynamic content to be referenced. For example, substrings of the form “{{name}}” may be replaced with the current value associated with “name”. Substrings may be used to (1) build URL strings from setting values, (2) to build URL strings from a response to a prior request, (3) to fill text elements from a combination of static and dynamic content, (4) to compare content items 314 to a constant value to determine whether to indicate that a condition has been met, (5) to compare content item values to an end-user-provided setting value to determine what icon to show on a micro-app, etc. Further, a formatting directive may be provided to facilitate the conversion of common web data types to human-readable text. For example, a formatting directive may allow unix-style timestamps to be converted to a date or date-time string.

Web-resource micro-app package 300 may specify how extracted content items 314 and other content group 315 are to be presented at companion computing device 210 on web-resource micro-app 235. Web-resource micro-app package 300 includes micro-app icon array 320, including icons that may be presented along with content group 315 of a web-resource micro-app 235. The contents of micro-app icon array 320 may be fixed so that all icons are transferred to companion computing device 210 when the web-resource micro-app 235 is installed. In other examples, new icons may be transferred to companion computing device 210 following installation. For each icon, an internal name may be associated with a relative path in an archive where the icon's PNG file is located.

Micro-app icon array 320 includes a primary micro-app icon 321, which may be used to represent web-resource micro-app 235 on companion computing device 210, primary computing device 205, and other graphical representations of web-resource micro-app 235, including web-resource micro-app management UIs. Primary micro-app icon 321 may thus be formatted for presentation across all operating systems and display resolutions. In some examples, primary micro-app icon 321 may be included in a variety of sizes and resolutions, allowing companion manager 215 to select a best icon for the current conditions from the available icons. For example, web-resource micro-apps 235 configured to supply badge counts (e.g., for web feeds) may include a badge icon 322 comprising a smaller version of primary micro-app icon 321 for use in badging.

Additional display icons 323 may be provided and presented alongside formatted content group 315 on companion computing device 210. Micro-app icon array 320 may include a meta-file listing all of the icons referenced by web-resource micro-app 235 so that they can be pre-loaded onto the companion computing device when the web-resource micro-app is first installed. Icon locations may be provided as full HTTP URLs. A location call may specify the location of each icon, and may provide a mapping template from icon size to icon location to allow for new icon sizes in the future.

Web-resource micro-app package 300 may include presentation parameters 330 for formatting predetermined content items 314 for presentation on companion computing device 210. Presentation parameters 330 include content group formatting parameters 331, specifying fonts, color, text size, style, etc. for each content item within a content group 315. Formatting parameters 331 may specify dynamic information for content group 315. For example, an individual content item 314 may blink or flash on the display, or otherwise be dynamically formatted to draw the attention of the end-user. Content group 315 may be configured to scroll across the display of companion computing device 210. For example, an individual content item 314 that contains a long string of text or data may scroll laterally across the display. A content group 315 comprising numerous items may scroll the items vertically across the display, to allow for presentation of the entire content group 315 without cluttering the display. In some examples, content items 314 may scroll automatically. In other examples, content items 314 may scroll responsive to user input.

A micro-app layout 332 may provide information about each display grouping for a web-resource micro-app 235, their layouts, and how their content is populated from the web-resources 230. In some examples, multiple micro-app layouts may be provided, for example, for presentation of different content groups 315 within a web-resource micro-app 235, for conditional presentation, etc. For example, a finances micro-app may indicate a stock name or symbol at the top of the layout, a first value indicating the stocks' performance in the center of the layout, and a second value estimating a total value of the end-user's stock holding at the bottom of the layout. A stock increasing in value may be accompanied by accompanied by a happy face icon, while a stock decreasing in value may be accompanied by a sad face icon. A stock changing value considerably may flash on the display.

Micro-app layouts 332 may include template layouts and/or custom layouts created by content developers, and may be described using an XML-based language. For each custom layout, an internal name may be associated with the relative path in the archive where the XML describing the layout can be found. Each micro-app layout 332 may include a layout name, referring to a predefined page layout or a custom page layout. Micro-app layouts 332 may further include a set of text binding objects, which include an array of objects corresponding to each content item 314 that contains string content. Each text binding object may provide a numeric id of the content item 314, and a string value that the content item 314 should contain. The string values may contain substitutions from the content portions of the resources list. Micro-app layouts 332 may further include a set of icon binding objects, which may be used to select one or more icons from micro-app icon array 320 for display along with content group 315.

When present and activated, a micro-app theme 333 may override any user-selected theme colors for the web-resource micro-app 235. Each micro-app theme 333 may be an object containing one or more overrides for individual theme colors. Any theme colors that are not specified may inherit their value from a current companion computing device theme. Color values may use the same format as color attributes in custom layout files.

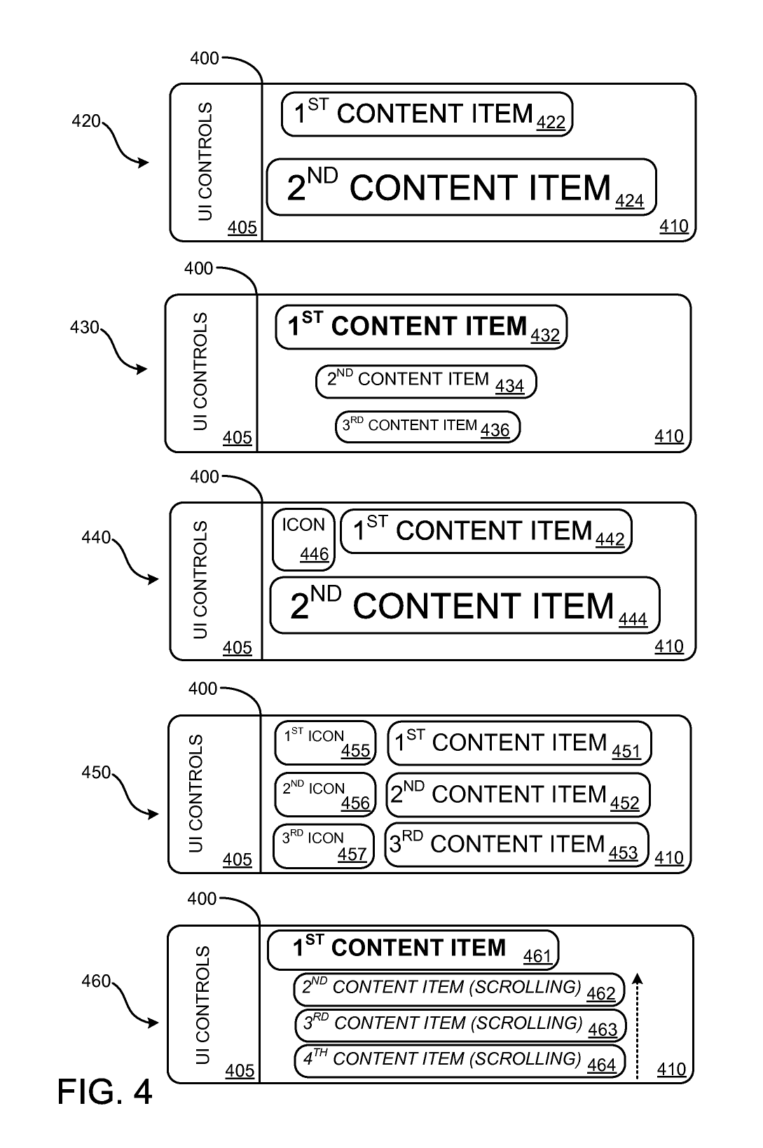

Turning to FIG. 4, some example web-resource micro-app layouts are depicted. Each example web-resource micro-app layout is formatted for a display 400, such as display 20 shown in FIG. 1A. Display 400 may be portioned into two regions—first region 405, comprising UI controls for the web-resource micro-app and companion computing device, and second region 410, comprising formatted content items, icons, etc. as specified by presentation parameters 330.

A first example web-resource micro-app layout is depicted at 420. A first content item 422 and second content item 424 are formatted and presented within second region 410. As a non-limiting example, first content item 422 may be a header or title, and second content item 424 may be a metric. In this example layout, the end-user may observe and process the first and second content items at a glance.

A second example web-resource micro-app layout is depicted at 430. A first content item 432, a second content item 434, and a third content item 436 are formatted and presented within second region 410. First content item is formatted to be presented in a bold style. As a non-limiting example, first content item 432 may be a headline of an article, second content item 434 may be a summary of the article, and third content item 436 may be a date and time the article was published. In this example layout, the end-user may be initially drawn to the first content item, and may then process additional information from the second and third content items.

A third example web-resource micro-app layout is depicted at 440. A first content item 442, a second content item 444, and an icon 446 are formatted and presented within second region 410. Icon 446 may be a default display icon retrieved from micro-app icon array 320, or may be a conditional icon presented based on data contained within first content item 442 and/or second content item 444. For example, if second content item 444 is a health metric showing an end-user improvement towards a health goal, icon 446 may provide positive reinforcement, such as a visual depiction of progress towards the health goal, or a thumbs-up symbol.

A fourth example web-resource micro-app layout is depicted at 450. A first content item 451, a second content item 452, and a third content item 453 are formatted and presented within second region 410 along with a first icon 455, a second icon 456, and a third icon 457. For example, three related metrics may be presented along with easily discernable icons for at-a-glance processing by the end-user. As a non-limiting example, a running application may present a completion time, an average heart rate, and a total caloric expenditure, along with icons depicting a stopwatch, a throbbing heart, and a cheeseburger.

A fifth example web-resource micro-app layout is depicted at 460. A first content item 461, a second content item 462, a third content item 463, and a fourth content item 464 are formatted and presented within second region 410. In this example, first content item 461 is statically displayed on display 400, while second content item 462, third content item 463, and fourth content item 464 scroll upwards on display 400. Additional content items may scroll onto the display, while the currently presented content items may scroll off of the display. For example, a scoreboard app may present a league and date as first content item 461, and may provide a scrolling set of scores for league games on that date. The scrolling may be automated or user-triggered, depending on the presentation parameters.

Returning to FIG. 3, web-resource micro-app package 300 further includes notification declarations 340. Each notification declaration 340 may include conditions 341 to be evaluated to determine whether to trigger a user notification 342. Notification declarations 340 may enable companion manager 215 to evaluate expressions that involve settings values or web content, and to determine whether to deliver a user notification 342 via companion computing device 210 when certain conditions 341 are detected in predetermined content items 314.

Conditions 341 may be written as a single string that can be parsed for operands and operators. Conditions 341 may be evaluated via a hosted JavaScript engine, for example, or via a simplified expression syntax with a limited set of data types and operators. Conditions 341 may include an array of condition objects that act like an if/else-if statement sequence.

Conditions 341 may be syntax-based, data-based, and/or based on a combination of factors. For example, conditions 341 for a content group 315 may comprise a presence of one or more keywords within a predetermined content item 314 of a content group 315, and/or may comprise the presence of a value greater than a threshold (or less than, equal to, etc.) within a predetermined content item 314 of the content group 315. In some examples, multiple sub-conditions may be combined together to satisfy a condition (e.g., values for multiple content group 315 greater than their respective thresholds). Conditions 341 may include scheduled or repeated conditions, such as reminders, and/or badging-type conditions, such as the availability of any new content. Values for conditions 341 may be adjustable by an end-user via an end-user setting 317. In some examples, default conditions may be set during installation of web-resource micro-app 235. The end-user may be presented an option to accept, decline, or adjust conditions 341 during installation, and may be further enabled to modify conditions 341 via a UI for the companion manager, or at companion computing device 210.

Notification declarations 340 further include user notifications 342. User notifications 342 may include instructions executable by companion manager 215 which indicate the companion computing device 210 to issue a user notification 342 responsive to a condition 341 being met. User notifications 342 may also include the content of the user notification 342. User notification 342 may be visual, aural, haptic, or any such combination thereof. For example, a user notification 342 may indicate text to use for a notification title, text to use for a notification body, a number of times to actuate a haptic motor, and a duration that must elapse before the same user notification 342 may be triggered again. In some examples, a user notification 342 may be presented in conjunction with an updated web-resource micro-app 235 comprising the predetermined content item 314 which triggered the user notification 342. In other examples, a user notification 342 may be presented independently from the associated content group 315.

Each notification declaration 340 may include one or more conditional presentation parameters 343. For example, an additional display icon 323 may be selected for presentation based on a condition 341 being met. One or more presentation parameters 330 may be adjusted based on a condition 341. For example, a content item 314 may be formatted differently from a default formatting parameter to draw the attention of the end-user. In some examples, a conditional micro-app layout 332 may be selected, or a micro-app theme 333 over-ridden.

Each notification declaration 340 may include one or more conditional settings 344. Conditional settings 344 may override specific settings 316. For example, a refresh interval for a web-resource 230 may be increased. In some examples, a secondary web-resource 230 may only be polled for data when a condition 341 is met for a content item 314 extracted from the primary web-resource 230. For example, a condition 341 being met for a first pre-determined content item 314 may indicate that additional pre-determined content items 314 may be available.

As a non-limiting example, a health-based web-resource micro-app on a smartwatch may be configured with a condition, in which blood glucose falling below a threshold triggers a notification. The notification may activate a vibration or audio/visual alarm at the smartwatch, as one example. Visual notifications may be displayed, indicating blood glucose levels, alert conditions, etc. User input to the smartwatch may then trigger display of a conditional micro-app layout, specifically associated with the triggering condition (i.e., not presented when blood glucose levels are normal). The conditional layout could, for example, provide additional instructions and information, such as an emphasis to eat certain foods or take other steps. The companion manager 215 may then increase the refresh rate of one or more web-resources for some amount of time, or until the blood glucose levels return to normal.

Conditions 341 may also include events, such as user-input events. For example, a content item or icon presented on a web-resource micro-app 235 may be associated with a condition 341 which is met responsive to a user contacting a touch-sensitive display at the site of presentation. Such a condition may be included in a notification declaration 340 which also includes conditional presentation parameters 343 and/or conditional settings 344. An action may be performed in response to the condition 341 being met, such as additional content items being displayed, or a forced refresh of the web-resource. For companion computing devices that include additional means of user input (e.g., push buttons, microphones, dials), conditions 341 may be indicated that are met responsive to receiving such user input. Associated conditional presentation parameters 343 and conditional settings 344 may be standardized for a user input condition across all web-resource micro-apps, or may be customized for a specific web-resource micro app 235. In some examples, end-user settings 317 may be associated with user-input conditions, allowing for an end-user to indicate a preferred action to associate with a user-input.

Returning to FIG. 2, a web-resource micro-app discovery point 240 may be provided to allow developers and end-users to author, update, discover, and manage web-resource micro-apps. Web-resource micro-app discovery point 240 may include a number of servers, cloud computing devices, etc., some of which may be accessible to the public, others of which may only be accessible to registered users.

Web-resource micro-apps 235 may be authored using any editing software preferred by a developer, or may be authored using a web-based authoring tool 242. Web-based authoring tool 242 may be configured with emulator support, allowing developers to build new web-resource micro-apps 235 interactively. Further, end-users may utilize web-based authoring tool 242 to build web-resource micro-apps 235 in order to assemble predetermined content items 314 into a content group 315 that has personal significance, or is otherwise unavailable to the end-user. In some examples, a client version of web-based authoring tool 242 may allow developers to edit and save web-resource micro-app packages 300 locally, prior to uploading to web-resource micro-app discovery point 240.

Web-based authoring tool 242 may include any number of authoring features. For example, default presentation parameter templates and/or pre-designed web-resource micro-app layouts may be provided, wherein the presentation parameters 330 for a web-resource micro-app 235 are set to default values. A developer may select a default template or pre-designed layout as the basis for presenting a content group 315. In some examples, the default presentation parameter values within a template may be editable to refine the appearance of the web-resource micro-app 235. Custom layouts may enable a developer to begin a set of presentation parameters 330 from scratch, and/or to pick and choose aspects of multiple pre-designed layouts to combine into a single micro-app design.

Web-based authoring tool 242 may further include any number of data resources. A developer may provide a location of a web-resource 230, and the data resources may aid the developer in identifying and locating predetermined content items 314 within a data bundle 231 retrieved from the web-resource 230. For secure, restricted, or private data resources, the developer may indicate one or more authentication factors required to access a web-resource 230. Web-based authoring tool 242 may further provide a prompt meta-file for the web-resource micro-app package 300, which may allow an end-user to indicate one or more additional authentication factors upon installation of the finalized web-resource micro-app package 300, such as a username and password required to access end-user specific data from a data resource.

Web-based authoring tool 242 may provide a micro-app preview resource, which may enable a developer to preview how the web-resource micro-app may appear as content items 314 and/or content group 315 are designated for placement within the web-resource micro-app 235. The developer may then adjust presentation parameters 330 and content group 315 based on the preview.

A developer may thus follow a high-level workflow for authoring a web-resource micro-app package with web-based authoring tool 242. The workflow may include: (1) selecting a presentation parameter template (or creating a custom layout) comprising a set of presentation parameters 330 having default values; (2) indicating a location of a web-resource 230; (3) identifying and locating pre-determined content items 314 within a data bundle 231 retrieved from the web-resource 230 via a web-based authoring tool data resource; (4) indicating additional presentation parameters 330 for content group 315, the content group 315 comprising at least one pre-determined content item 314; (5) selecting (and/or uploading) and indicating presentation parameters 330 for icons for a micro-app icon array 320; (6) adjusting presentation parameters 330 based on a micro-app preview generated by the web-based authoring tool 242; and (7) providing general information 311 regarding the web-resource micro-app. The developer may select values for micro-app settings 316, which may include default values for end-user settings 317. In some examples, the developer may provide notification declarations 340, including conditions 341, user notifications 342, conditional presentation parameters 343, and conditional settings 344.

Web-based authoring tool 242 may provide cloud storage for developers desiring to save a web-resource micro-app package 300 in progress (e.g., before finalizing the package). Upon finalizing the web-resource micro-app package 300, the developer may optionally download the web-resource micro-app package 300 to a local computing device. Web-based authoring tool 242 may optionally upload a completed web-resource micro-app package 300 to a public gallery 244, where end-users may view web-resource micro-app packages available for downloading. Public gallery 244, along with end-user companion computing device web dashboard 246, and/or companion computing device scheme handler 248, may track web-resource micro-app downloads, installations, removals, updates, data retrieved, etc. based on information provided by companion managers 215, in order to provide telemetry for developers and end-users.

After finalizing the web-resource micro-app package 300, the developer may return to web-based authoring tool 242 to update and/or edit the web-resource micro-app package 300 as needed. A developer signing in to the web-based authoring tool 242 may be presented with a list of web-resource micro-apps 235 authored or uploaded by the developer. If the web-resource micro-app 235 was authored using web-based authoring tool 242, the developer may then optionally update the web-resource micro-app package 300 directly using web-based authoring tool 242. In some scenarios, the developer may manually upload an updated web-resource micro-app package 300 to public gallery 244. Further, developers may clone an existing web-resource micro-app package 300 and edit one or more settings 316, presentation parameters 330, icons, or notification declarations 340.

When a web-resource micro-app package 300 has been finalized, the web-resource micro-app package 300 may be provided to end-users for discovery and installation. End-users may discover new web-resource micro-apps 235 using a variety of methods. For example, end-users may discover a web-resource micro-app 235 via social media or other resources which provide a direct link to a web-resource micro-app 235. For example, an end-user may receive a link to a web-resource micro-app package 300 via text message, email, or other link sharing tool. In some examples, web-resource micro-app packages 300 may be directly shared via email or other file-sharing means. End-users may discover a web-resource micro-app 235 via public gallery 244, or via end-user companion computing device web dashboard 246. For example, a first end-user may direct a second end-user to a web-resource micro-app 235 using a ‘share’ functionality available in public gallery 244 or end-user companion computing device web dashboard 246. Public gallery 244 and end-user companion computing device web dashboard 246 may provide access to the same web-resource micro-apps 235; however, end-user companion computing device web dashboard 246 may be restricted to registered users of companion computing device 210 or another device or service.

End-user companion computing device web dashboard 246 may be a web-based interface for managing companion computing device 210 that is accessible via primary computing device 205, as well as via additional computing devices contingent upon end-user authentication. End-user companion computing device web dashboard 246 may thus selectively present web-resource micro-apps 235 of interest to an end-user based on end-user data, such as companion computing device configuration, apps stored on primary computing device 205 and/or micro-apps stored on companion computing device 210, the end-user's download history, web-browsing history, companion computing device usage history, etc.

Turning to FIG. 5, an example method 500 is depicted for installation of a web-resource micro-app package, such as web-resource micro-app package 300 at a primary computing device, such as primary computing device 205. At 510, method 500 includes requesting a web-resource micro-app package 300 from a host site, for example, by clicking on a link, or requesting to install a web-resource micro-app 235 via public gallery 244 or end-user companion computing device web dashboard 246. Requesting a web-resource micro-app package 300 may result in the activation of companion manager 215 and/or the triggering of an installation workflow via companion manager 215. If companion manager 215 is not available (e.g., an end-user requests a web-resource micro-app 235 via web dashboard 246 from an alternate computing device while primary computing device 210 is offline), the end-user may be redirected to a site comprising instructions on how to download and install the web-resource micro-app package 300. When web-resource micro-app packages 300 are accessed via hyperlinks, companion computing device scheme handler 248 may launch a custom URL scheme which may be used to activate the installation workflow via companion manager 215.

Continuing at 520, method 500 includes downloading the requested web-resource micro-app package 300 from the host site. If the web-resource micro-app package 300 was requested via a hyperlink, companion manager 215 may present an authorization UX to the end-user in order to verify that the end-user wishes to install the web-resource micro-app 235 prior to initiating the download. Web-resource micro-app packages 300 delivered as email attachments or files may trigger the installation workflow without requiring the end-user to specifically request or download the package. If a hyperlink to a web-resource micro-app package 300 is invalid, both the end-user and the hyperlink provider may be notified.

In some examples, the end-user may save the web-resource micro-app package 300 locally, but complete installation at a later time point. When requesting a web-resource micro-app package 300 via end-user companion computing device web dashboard 246, the web-resource micro-app package 300 may be saved at a cloud storage device prior to being downloaded to the primary computing device 205 (See FIG. 6 for additional details). Downloading a web-resource micro-app package 300 may be dependent on storage availability at primary computing device 205, and/or companion computing device 210. For example, there may be a limit as to how many web-resource micro-apps 235 may be enabled on companion computing device 210 at any given time. The end-user may thus be prompted that downloading the web-resource micro-app package 300 will be suspended until additional storage space is made available, and may be prompted again to indicate if the downloading and installation of the web-resource micro-app package 300 is still desired when storage space requirements are met.

In some examples, downloading and subsequent installation of the web-resource micro-app package 300 may be dependent on companion computing device 210 being communicatively coupled to primary computing device 205. If companion manager 215 is unable to access companion computing device 210, the end-user may be notified via a system dialog at primary computing device 205. For example, a system dialog may indicate: “I can't find your companion computing device. Please make sure it is nearby and paired to the primary computing device.”

When the web-resource micro-app package 300 has been downloaded to primary computing device 205, method 500 proceeds to 530, where the web-resource micro-app package 300 is parsed and validated. For example, if the web-resource micro-app package 300 was downloaded as a compressed file (e.g., a zip archive), the compressed package file may first be expanded. The web-resource micro-app package 300 may then be evaluated for the presence of any malware, and a determination may be made as to whether the web-resource micro-app package 300 includes all of the necessary files for installation, and whether the included files are of a supported format. If the web-resource micro-app package 300 cannot be validated by companion manager 215, the end-user may be notified and the web-resource micro-app package 300 may be deleted from primary computing device 205. If the web-resource micro-app package 300 is validated, companion manager 215 may then request that the end-user authorize continuation of the installation.

Continuing at 540, method 500 includes installing and storing the web-resource micro-app package 300 at primary computing device 205. Companion manager 215 may archive and record a location of each file of the web-resource micro-app package 300 on primary computing device 205. Web-resource locations may be validated, an example data bundle 231 may be retrieved from each specified web-resource 230, and specified pre-determined content items 314 may be extracted from the example data bundle. If any of the specified web-resource parameters 312 are invalid, installation may be aborted.

Continuing at 550, method 500 includes generating a web-resource micro-app 235 based on the installed web-resource micro-app package 300. The web-resource micro-app 235 may be authored for installation and execution on companion computing device 210, and may include icons, fonts, content group 315, instructions for providing user notifications 342, and any other files, instructions, and/or parameters necessary to execute the web-resource micro-app 235 at companion computing device 210, to present extracted data based on the presentation parameters 330, and/or to enable data transfer between companion manager 215 and the web-resource micro-app 235 when updated or new data becomes available.

Continuing at 560, method 500 includes installing the web-resource micro-app 235 at companion computing device 210. The generated web-resource micro-app 235 may be uploaded from primary computing device 205 to companion computing device 210, where the web-resource micro-app 235 may be installed alongside other micro-apps. The companion computing device UI may be updated to reflect the newly installed web-resource micro-app 235.

Following installation, the end-user may remove the web-resource micro-app 235 from companion computing device 210 by requesting to disable the web-resource micro-app 235 via companion manager 215, or via end-user companion computing device web dashboard 246. A disabled web-resource micro-app 235 may remain visible in any list of micro-apps associated with the end-user. The web-resource micro-app package 300 may remain installed on primary computing device 205 and/or may remain stored on a cloud storage site.

Any prior personalization, such as end-user setting 317 values, may be persisted in an end-user's web-resource micro-app library, in case the web-resource micro-app 235 is re-enabled on the companion computing device 210 at a later time point. Any authorization tokens obtained during installation may remain stored on primary computing device 205 and/or companion computing device 210. End-users may also permanently remove the web-resource micro-app 235 via companion manager 215, via a companion computing device UI, and/or via end-user companion computing device web dashboard 246.

If the installed web-resource micro-app 235 is removed via companion manager 215 or via end-user companion computing device web dashboard 246, it may automatically be removed from companion computing device 210. A micro-app library maintained in companion manager 215 and/or in companion computing device 210 may be automatically updated when micro-apps are permanently removed via end-user companion computing device web dashboard 246.

Returning to FIG. 2, end-users of companion computing device 210 may optionally subscribe to companion computing device cloud services 250. Companion computing device cloud services 250 may provide data storage, cloud computer-based processing, and synchronization services. Cloud services 250 may enable backing up of companion computing device 210, temporary and/or permanent storage of files associated with companion computing device 210, and off-loading of data retrieval and processing from primary computing device 205 and/or companion computing device 210. Cloud services 250 may enable synchronization between primary computing device 205, companion computing device 210, end-user companion computing device web dashboard 246, etc. Cloud services 250 may manage, retrieve, and update data, including pre-determined content items specified for presentation on companion computing device micro-apps.

Companion computing device cloud services 250 includes micro-app API 252, which may be communicatively coupled to web-based authoring tool 242, public gallery 244, end-user companion computing device web dashboard 246, as well as web-resources 230. Micro-app API 252 may manage versions, parameters, and settings for each micro-app, and may retrieve and extract content items from web-resources 230 based on the parameters specified in each micro-app package.

Companion computing device cloud services 250 further includes micro-app storage 254. Micro-app storage 254 may include micro-app packages and associated files, settings, parameters, preferences, data, usage history, etc. for each micro-app. Disabled micro-apps, which are not currently stored on companion computing device 210, may be maintained in micro-app storage 254 in order to enable rapid re-installation upon the (re)enabling of a micro-app.

Companion computing device cloud services 250 further includes micro-app sync 256. Micro-app sync 256 may receive updates from micro-app API 252, which may include updates retrieved from web-based authoring tool 242, public gallery 244, end-user companion computing device web dashboard 246, companion manager 215, secondary computing device 210, and web-resources 230. Micro-app sync 256 may indicate updates to companion manager 215 via operating system push services 258. Operating system push services 258 may indicate the availability of new and/or updated information to companion manager 215 executing on operating system 212.

Each operating system push service 258 may be configured to send push notifications to end-users that subscribe to receive push notifications. Therefore, end-users of a micro-app may or may not elect to receive push notifications. Further, end-users may elect to conditionally receive push notifications. An end-user may subscribe to receive push notifications at any suitable time. Further, it will be understood that an end-user may cancel or change a subscription at any suitable time.

Different operating systems 212 may be affiliated with different operating system push services 258, which may deliver updates specifically formatted for translation and/or execution on primary computing device 205. Operating system push services 258 may be a clearing house configured to accept a push notification request from micro-app sync 256, and process a request such that it may be received at primary computing device 205.

FIG. 6 depicts a flowchart for an example method 600 for installing a web-resource micro-app package 300 at a primary computing device 205 using a cloud computing service 250. At 605, method 600 includes receiving a request to install a web-resource micro-app 235. For example, an end-user may request a web-resource micro-app 235 via public gallery 244 or end-user companion computing device web dashboard 246. End-users may have the option to save a web-resource micro-app package 300 to micro-app storage 254 for later installation (i.e. as a disabled micro-app) or to install it immediately (i.e. as an enabled micro-app). A web-resource micro-app library for an end-user may thus be divided into enabled and disabled web-resource micro-apps 235.

At 610, method 600 includes retrieving a web-resource micro-app package 300 from a host site. For example, the web-resource micro-app package 300 may be pushed from end-user companion computing device web dashboard 246, web-based authoring tool 242, or public gallery 244. Continuing at 615, method 600 includes parsing and validating the retrieved web-resource micro-app package 300. If the web-resource micro-app package 300 is in an unsupported format, micro-app API 252 may alert web-resource micro-app discovery point 240, so that an error message can be invoked, and both the end-user and developer may be notified.

At 620, method 600 includes storing the web-resource micro-app package 300 as a disabled web-resource micro-app package at micro-app storage 254. Continuing at 625, method 600 includes indicating the availability of the web-resource micro-app package 300 to the companion manager 215. For example, micro-app sync 256 may submit a notification to operating system push services 258, which may then relay the notification to companion manager 215. In some scenarios, companion manager 215 may request confirmation from the end-user to begin installation of the web-resource micro-app package 300. In scenarios where companion manager 215 is not available when the end-user first clicks on the web-resource micro-app package link, the end-user may have to restart the web-resource micro-app installation process (i.e. click the web-resource micro-app link again) after they finish installing the companion manager 215 and setting up the companion computing device 210, for example.

At 630, method 600 includes receiving a request from the companion manager 215 for the web-resource micro-app package 300. For example, companion manager 215 may submit a notification to operating system push services 258, which may then relay the notification to micro-app sync 256. If micro-app sync 256 is unreachable, companion manager 215 may place the web-resource micro-app package 300 in a download queue. If no request is received from companion manager 215, the web-resource micro-app package 300 may be maintained at micro-app storage 254 as a disabled micro-app. Continuing at 635, method 600 includes downloading the web-resource micro-app package 300 to the primary computing device 205.

At 640, method 600 includes installing the web-resource micro-app 235 at the companion computing device, as depicted in FIG. 5 and described with reference to 530-560 of method 500. Upon completion of the installation of the web-resource micro-app 235 at companion computing device 210, companion manager 215 may output a notification confirming installation, indicating whether the web-resource micro-app 235 has been enabled, and indicating whether the end-user has updated any settings 316, parameters, and/or notification declarations 340. If companion computing device cloud services 250 are not reachable, the notification may be placed in an upload queue At 645, method 600 includes receiving a confirmation of installation of the web-resource micro-app 235 from companion manager 215. Continuing at 650, method 600 includes storing updated web-resource micro-app information at micro-app storage 254.

Once a web-resource micro-app 235 is installed at the companion computing device 210, the end-user may manage settings, parameters, etc. for the web-resource micro-app 235 using the companion computing device 210, the companion manager 215, and/or the companion web dashboard 246. Companion computing device cloud services 250 may synchronize any updates to a web-resource micro-app 235, so that the same variables are stored at the cloud 250, primary device 205, companion device 210, and web dashboard 246.

For example, if an end-user manages web-resource micro-apps 235 via companion manager 215, the companion manager 215 may alert micro-app API 252 that the status of the web-resource micro-app 235 has been changed. Upon receiving the alert, web-resource micro-app API 252 updates the status of the web-resource micro-app 235 at micro-app storage 254.

If an end-user updates the status of a currently installed web-resource micro-app 235 using the companion computing device web dashboard 246, micro-app API 252 may be notified, and in turn, may notify companion manager 215. If companion manager 215 is unreachable, micro-app API 252 may notify web dashboard 246 so that an error message can be invoked. Upon receiving the notification, companion manager 215 may retrieve the status update from micro-app API 252. The status update may be placed in a download queue if companion computing device cloud services 250 are unreachable. Once the status update has been downloaded, companion manager 215 may update the status of the web-resource micro-app 235 at primary computing device 205, and may further update the status of the web-resource micro-app 235 at secondary computing device 210. If the status update is a complete removal, the web-resource micro-app 235 may be removed from a list of available micro-apps at the secondary computing device 210.

Once the web-resource micro-app status has been updated, companion manager 215 may alert micro-app API 252 that the status of the web-resource micro-app 235 has been changed. Upon receiving the alert micro-app API 252 may update the status of the web-resource micro-app 235 at micro-app storage 254. When there are new updates available for a web-resource micro-app package 300, responsive to launching companion manager 215 or end-user companion computing device web dashboard 246, the end-user may receive a notification and be able to update the respective web-resource micro-apps 235 at both companion computing device 210 and at companion computing device cloud services 250.

Turning to FIG. 7, a flow-chart is depicted for an example method 700 for updating content on a web-resource micro-app 235. At 710, method 700 includes periodically polling a web-resource 230 for data as specified in the web-resource micro-app parameters 312 via the companion manager 215. The web-resource micro-app settings 316 may specify an interval between content updates (e.g., every 30 min). However, this may depend on resources available at the primary computing device 205, available network bandwidth, etc. At 720, method 700 includes retrieving a data bundle 231 from the web-resource 230, and may include downloading the data bundle 231 to the primary computing device 205. In some examples, a data bundle 231 may only be retrieved when new content is available (such as for feed-based web-resources). In other examples, a data bundle 231 may be retrieved regardless of whether content has been updated since a most recent retrieval. Standardized web protocols, such as HTTP, may provide a variety of mechanisms for efficiently indicating whether a web-resource has been changed since a most recent data bundle retrieval. Companion manager 215 may be configured to evaluate a web-resource 230 for an indication of new or updated content, thus avoiding unnecessary retrieval and processing of a data bundle that does not include new or updated data.

Continuing at 730, method 700 includes parsing and validating the data bundle. If the data bundle 231 is invalid, the companion manager 215 may notify the web-resource 230, and may adjust data retrieval from the web-resource 230 if appropriate. If and when the data bundle 231 is validated, method 700 proceeds to 740, and includes extracting predetermined content items 314 from the data bundle 231 as specified in the web-resource micro-app parameters 312. The companion manager 215 may then compare the extracted predetermined content items 314 with previously extracted predetermined content items 314 to determine whether new or updated content has been retrieved. If no new or updated content has been retrieved, method 700 may then end.

If new or updated content has been retrieved, method 700 may proceed to 750, and includes storing new or updated data for the predetermined content items 314. If notification declarations 340 exist for one or more of the predetermined content items 314, the new or updated data may be evaluated to determine whether a condition 341 has been met.

Continuing at 760, method 700 includes formatting the new or updated data according to the presentation parameters 330 for the specified content group 315. Predetermined content items 314 that have not been updated may maintain a previous formatting, unless conditional presentation parameters 343 have been met specifying otherwise. At 770, method 700 includes exporting the formatted data from the primary computing device 205 to the companion computing device 210, along with any user notifications 342.

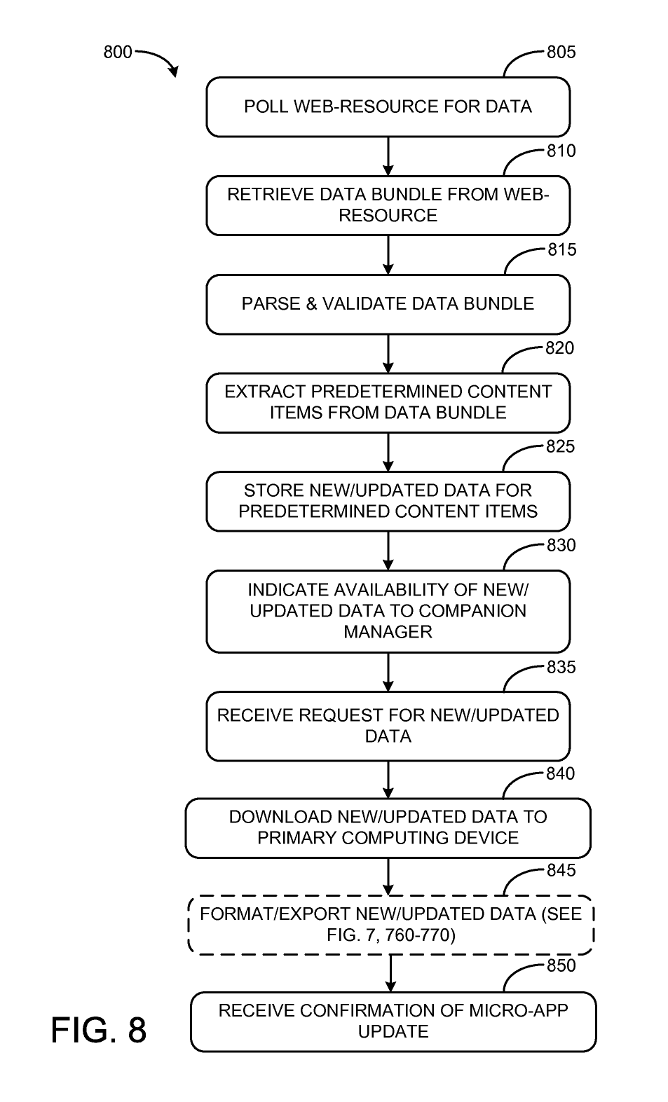

FIG. 8 shows a flow-chart for an additional method 800 of updating content on a web-resource micro-app 235 using a cloud computing service 250. At 805, method 800 includes periodically polling a web-resource 230 for data via a cloud based micro-app API 252 as specified in the web-resource micro-app parameters 312. At 810, method 800 includes retrieving a data bundle 231 from the web-resource 230, and may include downloading the data bundle 231 to the cloud-based micro-app storage 254. At 815, method 800 includes parsing and validating the data bundle. If the data bundle 231 is invalid, the micro-app API 252 may notify the web-resource 230, and may adjust data retrieval from the web-resource 230 if appropriate. If and when the data bundle 231 is validated, method 800 proceeds to 820, and includes extracting predetermined content items 314 from the data bundle 231 as specified in the web-resource micro-app parameters 312. The micro-app API 252 may then compare the extracted predetermined content items 314 with previously extracted predetermined content items 314 to determine whether new or updated content has been retrieved. If no new or updated content has been retrieved, method 800 may then end. In some examples, micro-app API 252 may be configured to determine whether new or updated data is available without retrieving or downloading data bundle 231 from web-resource 230.

If new or updated content has been retrieved, method 800 proceeds to 825, and includes storing new or updated data for the predetermined content items 314 at the cloud-based micro-app storage 254. Continuing at 830, method 800 includes indicating to the companion manager 215 the availability of new or updated data via operating systems push services 258. If the companion manager 215 is not reachable, the indication may be placed in a queue, and delivery retried at a later time point. At 835, method 800 includes receiving a request for the new or updated data from the companion manager 215. Upon receiving the request, method 800 proceeds to 840, and includes downloading the new or updated data to the primary computing device 205 via operating systems push services 258.

Continuing at 845, method 800 includes formatting the new or updated data according to the presentation parameters 330 for the specified content group. Formatting may occur at the primary computing device 205, as depicted in FIG. 7, and described with reference to 760-770 of method 700. The companion manager 215 may also determine whether and conditions 341 have been met by the new or updated data, and manage any notification declarations 340 accordingly. The formatted data may then be exported from the primary computing device 205 to the companion computing device 210, along with any user notifications 342, and the companion manager 215 may output a notice of confirmation indicating a successful update to the web-resource micro-app 235. At 850, method 800 includes receiving the notice of confirmation at the micro-app API 252, and may further include updating data at the cloud-based micro-app storage 254.

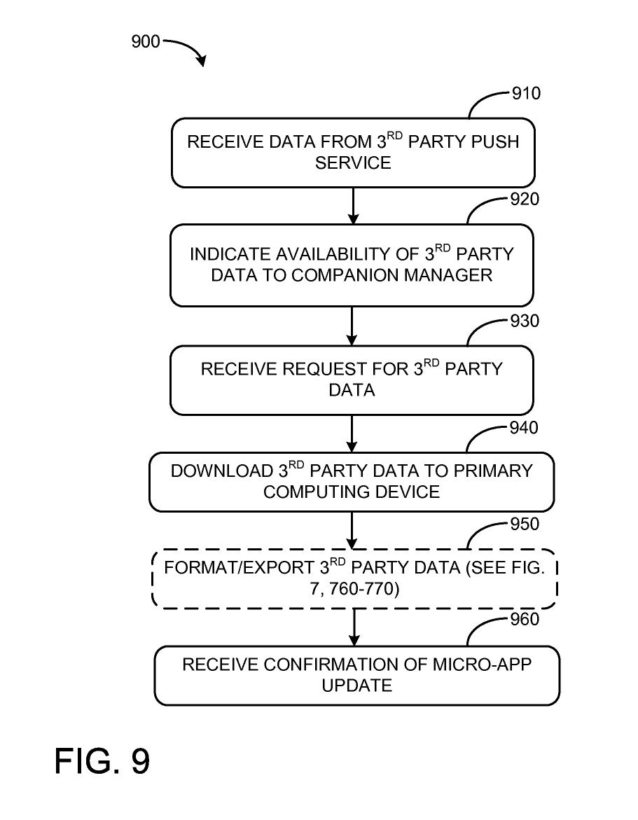

In some examples, a third party may push a notification of newly available content. As shown in FIG. 2, 3^{rd} party push services 260 may push notifications to micro-app API 252, and/or directly to companion manager 215. For example, a third party retailer may indicate an event such as a sale, accompanied by an icon, such as a QR code for a coupon. FIG. 9 shows a flow chart for an example method 900 for presenting content received from a 3^{rd} party push service 260 on a web-resource micro-app 235 using companion computing device cloud services 250. At 910, method 900 includes receiving data from a 3^{rd} party push service 260 at the cloud-based micro-app API 252. The micro-app API 252 may parse and validate the pushed data, may confirm whether the end-user desires to receive content from the 3^{rd} party, and may store the pushed data at the cloud-based micro-app storage 254. At 920, method 900 includes indicating the companion manager 215 to the availability of pushed data via operating system push services 258. If the companion manager 215 is not reachable, the indication may be placed in a queue, and delivery retried at a later time point. At 930, method 900 includes receiving a request for the pushed data from the companion manager 215. Upon receiving the request, method 900 proceeds to 940, and includes downloading the pushed data to the primary computing device 205 via operating systems push services 258.

Continuing at 950, method 800 includes formatting the pushed data according to the presentation parameters 330 for the specified content group 315. Formatting may occur at the primary computing device 205, as depicted in FIG. 7, and described with reference to 760-770 of method 700. The companion manager 215 may also determine whether the pushed data is accompanied by any notification declarations 340. The formatted data may then be exported from the primary computing device 205 to the companion computing device 210, along with any user notifications 342, and the companion manager 215 may output a notice of confirmation indicating a successful update to the web-resource micro-app 235. At 960, method 800 includes receiving the notice of confirmation at the micro-app API 252, and may further include updating data at the cloud-based micro-app storage 254.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 10 schematically shows a non-limiting embodiment of a computing system 1000 that can enact one or more of the methods and processes described above. Computing system 1000 is shown in simplified form. Computing system 1000 may take the form of one or more personal computers, server computers, tablet computers, home-entertainment computers, network computing devices, gaming devices, mobile computing devices, mobile communication devices (e.g., smart phone), and/or other computing devices.

Computing system 1000 includes a logic machine 1010 and a storage machine 1020. Computing system 1000 may optionally include a display subsystem 1030, input subsystem 1040, communication subsystem 1050, and/or other components not shown in FIG. 10.

Logic machine 1010 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 1020 includes one or more physical devices configured to hold instructions executable by the logic machine to implement the methods and processes described herein. When such methods and processes are implemented, the state of storage machine 1020 may be transformed—e.g., to hold different data.

Storage machine 1020 may include removable and/or built-in devices. Storage machine 1020 may include optical memory (e.g., CD, DVD, HD-DVD, Blu-Ray Disc), semiconductor memory (e.g., RAM, EPROM, EEPROM), and/or magnetic memory (e.g., hard-disk drive, floppy-disk drive, tape drive, MRAM), among others. Storage machine 1020 may include volatile, nonvolatile, dynamic, static, read/write, read-only, random-access, sequential-access, location-addressable, file-addressable, and/or content-addressable devices.

It will be appreciated that storage machine 1020 includes one or more physical devices. However, aspects of the instructions described herein alternatively may be propagated by a communication medium (e.g., an electromagnetic signal, an optical signal) that is not held by a physical device for a finite duration.

Aspects of logic machine 1010 and storage machine 1020 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1000 implemented to perform a particular function. In some cases, a module, program, or engine may be instantiated via logic machine 1010 executing instructions held by storage machine 1020. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 1030 may be used to present a visual representation of data held by storage machine 1020. This visual representation may take the form of a graphical user interface (GUI). As the herein described methods and processes change the data held by the storage machine, and thus transform the state of the storage machine, the state of display subsystem 1030 may likewise be transformed to visually represent changes in the underlying data. Display subsystem 1030 may include one or more display devices utilizing virtually any type of technology. Such display devices may be combined with logic machine 1010 and/or storage machine 1020 in a shared enclosure, or such display devices may be peripheral display devices.

When included, input subsystem 1040 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1050 may be configured to communicatively couple computing system 1000 with one or more other computing devices. Communication subsystem 1050 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1000 to send and/or receive messages to and/or from other devices via a network such as the Internet.

Computing system 1000 may include companion computing device manager 1060, which may be communicatively coupled to logic machine 1010 and storage machine 1020. Companion computing device manager 1060 may facilitate communication between computing system 1000 and companion computing device 1070. Companion computing device manager 1060 may receive data from and transmit data to companion computing device 1070, via communication subsystem 1050. Companion computing device 1070 may also include a logic machine, storage machine, display subsystem, input subsystem, communication subsystem, and/or other components not shown in FIG. 10. Wearable electronic device 10 is an example of companion computing device 1070.

In one example implementation, a system for presenting content on a companion computing device comprises a primary computing device associated with the companion computing device; a companion manager configured to execute on the primary computing device; and a web-resource micro-app package configured, when operating in concert with the companion manager, to control delivery and presentation of content on the companion computing device, the web-resource micro-app package being cross-platform and thus operable, without modification, with any of a plurality of different operating systems with which the companion manager and primary computing device might be associated, the web-resource micro-app package including: a location of a web-resource; identification of predetermined content items to be extracted from the web-resource; and presentation parameters for formatting a content group including at least some of the predetermined content items for presentation on the companion computing device. In one example implementation that optionally may be combined with any of the features described herein, the web-resource micro-app package further comprises locations of the predetermined content items within data bundles retrieved from the web-resource. In one example implementation that optionally may be combined with any of the features described herein, the web-resource micro-app package further comprises: icons to be presented on the companion computing device; and presentation parameters for displaying at least one icon on the companion computing device along with a formatted content group. In one example implementation that optionally may be combined with any of the features described herein, the web-resource micro-app package further comprises one or more notification declarations for the content group, each notification declaration comprising: a condition for the content group; and a user notification to be issued by the companion computing device responsive to the condition being met. In one example implementation that optionally may be combined with any of the features described herein, the companion manager is configured to: determine whether the condition for the content group is met; and responsive to the condition for the content group being met, provide an indication to the companion computing device to issue the user notification. In one example implementation that optionally may be combined with any of the features described herein, the one or more conditions for the content group comprise a presence of one or more keywords within a predetermined content item of the content group. In one example implementation that optionally may be combined with any of the features described herein, the one or more conditions for the content group comprise a presence of a value greater than a threshold within a predetermined content item of the content group. In one example implementation that optionally may be combined with any of the features described herein, the web-resource micro-app package further comprises: one or more authentication factors required to access an encrypted web-resource. In one example implementation that optionally may be combined with any of the features described herein, the web-resource micro-app package further comprises: one or more end-user settings adjustable by an end-user of the companion computing device to modify a parameter of the web-resource micro-app package.

In another example implementation, a method of delivering content to a companion computing device associated with a primary computing device comprises: generating a web-resource micro-app package configured, when operating in concert with a companion manager executing on the primary computing device, to control delivery and presentation of content on the companion computing device, the web-resource micro-app package being cross-platform and thus operable, without modification, with any of a plurality of different operating systems with which the companion manager and primary computing device might be associated, the web-resource micro-app package comprising: a location of a web-resource; identification of predetermined content items to be extracted from the web-resource; and presentation parameters for formatting a content group including at least some of the predetermined content items for presentation on the companion computing device; responsive to receiving a request to install a web-resource micro-app on the companion computing device, downloading the web-resource micro-app package to the primary computing device; installing the web-resource micro-app package on the primary computing device; at the companion manager, generating a web-resource micro-app based on the web-resource micro-app package; and installing the web-resource micro-app on the companion computing device. In one example implementation that optionally may be combined with any of the features described herein, the web-resource micro-app package is generated via an authoring tool comprising a plurality of presentation parameter templates for formatting a content group for presentation on the companion computing device. In one example implementation that optionally may be combined with any of the features described herein, the method further comprises selecting a presentation parameter template comprising a plurality of presentation parameters; indicating a location of a web-resource; indicating an identity and a location for pre-determined content items within a data bundle retrieved from the web-resource; and indicating additional presentation parameters for each content group member, the content group comprising at least one pre-determined content item. In one example implementation that optionally may be combined with any of the features described herein, the method further comprises indicating an authentication factor required to access the web-resource. In one example implementation that optionally may be combined with any of the features described herein, the method further comprises following installation of the web-resource micro-app on the companion computing device, retrieving a data bundle from the web-resource; extracting predetermined content items from the data bundle; formatting a content group including at least some of the predetermined content items for presentation on the companion computing device according to the presentation parameters; and exporting the formatted content group from the primary computing device to the companion computing device. In one example implementation that optionally may be combined with any of the features described herein, the method further comprises at a cloud computing service for the companion computing device, retrieving a data bundle from the web-resource data feed; extracting one or more predetermined content items from the retrieved data bundle; and indicating availability of new data to the companion manager. In one example implementation that optionally may be combined with any of the features described herein, the method further comprises at the cloud computing service for the companion computing device, receiving a request from the companion manager to download the new data; and exporting the new data to the companion manager. In one example implementation that optionally may be combined with any of the features described herein, the method further comprises at the cloud computing service for the companion computing device, receiving pushed data from a 3^{rd} party push service; indicating availability of pushed data to the companion manager; receiving a request from the companion manager to download the pushed data; and exporting the pushed data to the companion manager.

In yet another example implementation, a method for presenting content on a companion computing device comprises: at a primary computing device associated with the companion computing device, evaluating predetermined content items extracted from a web-resource based on a condition, the condition included in a web-resource micro-app package operable by a companion manager configured to execute on the primary computing device, the web-resource micro-app package being cross-platform and thus operable, without modification, with any of a plurality of different operating systems with which the companion manager and primary computing device might be associated; responsive to the condition being met by the predetermined content items, retrieving from the web-resource micro-app package a user notification to be issued by the companion computing device; formatting the predetermined content items for presentation on the companion computing device based at least on a conditional presentation parameter; and exporting the formatted predetermined content items to the companion computing device along with an indication to the companion computing device to issue the user notification. In one example implementation that optionally may be combined with any of the features described herein, the predetermined content items are extracted from a web-resource at a cloud service for the companion computing device, and wherein the cloud service exports the extracted predetermined content items to the primary computing device via an operating system push service for an operating system executing on the primary computing device. In one example implementation that optionally may be combined with any of the features described herein, the method further comprises responsive to the condition being met by the predetermined content items, retrieving any conditional icons associated with the conditions; and formatting the predetermined content items and conditional icons for presentation on the companion computing device.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A system for presenting content on a companion computing device comprising:
a primary computing device associated with the companion computing device;
a companion manager configured to execute on the primary computing device; and
a web-resource micro-app package configured, when operating in concert with the companion manager, to control delivery and presentation of content on the companion computing device, the web-resource micro-app package being cross-platform and thus operable, without modification, with any of a plurality of different operating systems with which the companion manager and primary computing device might be associated, the web-resource micro-app package including:
a location of a web-resource;
identification of predetermined content items to be extracted from the web-resource; and
presentation parameters for formatting a content group including at least some of the predetermined content items for presentation on the companion computing device.

2. The system of claim 1, wherein the web-resource micro-app package further comprises:
locations of the predetermined content items within data bundles retrieved from the web-resource.

3. The system of claim 1, wherein the web-resource micro-app package further comprises:
icons to be presented on the companion computing device; and
presentation parameters for displaying at least one icon on the companion computing device along with a formatted content group.

4. The system of claim 1, wherein the web-resource micro-app package further comprises one or more notification declarations for the content group, each notification declaration comprising:
a condition for the content group; and
a user notification to be issued by the companion computing device responsive to the condition being met.

5. The system of claim 4, wherein the companion manager is configured to:
determine whether the condition for the content group is met; and
responsive to the condition for the content group being met, provide an indication to the companion computing device to issue the user notification.

6. The system of claim 5, wherein the one or more conditions for the content group comprise a presence of one or more keywords within a predetermined content item of the content group.

7. The system of claim 5, wherein the one or more conditions for the content group comprise a presence of a value greater than a threshold within a predetermined content item of the content group.

8. The system of claim 1, wherein the web-resource micro-app package further comprises:
one or more authentication factors required to access an encrypted web-resource.

9. The system of claim 1, wherein the web-resource micro-app package further comprises:
one or more end-user settings adjustable by an end-user of the companion computing device to modify a parameter of the web-resource micro-app package.

10. A method of delivering content to a companion computing device associated with a primary computing device, comprising:
generating a web-resource micro-app package configured, when operating in concert with a companion manager executing on the primary computing device, to control delivery and presentation of content on the companion computing device, the web-resource micro-app package being cross-platform and thus operable, without modification, with any of a plurality of different operating systems with which the companion manager and primary computing device might be associated, the web-resource micro-app package comprising:
a location of a web-resource;
identification of predetermined content items to be extracted from the web-resource; and
presentation parameters for formatting a content group including at least some of the predetermined content items for presentation on the companion computing device;
responsive to receiving a request to install a web-resource micro-app on the companion computing device, downloading the web-resource micro-app package to the primary computing device;
installing the web-resource micro-app package on the primary computing device;
at the companion manager, generating a web-resource micro-app based on the web-resource micro-app package; and
installing the web-resource micro-app on the companion computing device.

11. The method of claim 10, wherein the web-resource micro-app package is generated via an authoring tool comprising a plurality of presentation parameter templates for formatting a content group for presentation on the companion computing device.

12. The method of claim 11, further comprising:
selecting a presentation parameter template comprising a plurality of presentation parameters;
indicating a location of a web-resource;
indicating an identity and a location for pre-determined content items within a data bundle retrieved from the web-resource; and
indicating additional presentation parameters for each content group member, the content group comprising at least one pre-determined content item.

13. The method of claim 12, further comprising:
indicating an authentication factor required to access the web-resource.

14. The method of claim 10, further comprising:
following installation of the web-resource micro-app on the companion computing device, retrieving a data bundle from the web-resource;
extracting predetermined content items from the data bundle;
formatting a content group including at least some of the predetermined content items for presentation on the companion computing device according to the presentation parameters; and
exporting the formatted content group from the primary computing device to the companion computing device.

15. The method of claim 10, further comprising:
at a cloud computing service for the companion computing device, retrieving a data bundle from the web-resource data feed;
extracting one or more predetermined content items from the retrieved data bundle; and
indicating availability of new data to the companion manager.

16. The method of claim 15, further comprising:
at the cloud computing service for the companion computing device, receiving a request from the companion manager to download the new data; and
exporting the new data to the companion manager.

17. The method of claim 15, further comprising:
at the cloud computing service for the companion computing device, receiving pushed data from a 3^{rd} party push service;
indicating availability of pushed data to the companion manager;
receiving a request from the companion manager to download the pushed data; and
exporting the pushed data to the companion manager.

18. A method for presenting content on a companion computing device, comprising:
at a primary computing device associated with the companion computing device, evaluating predetermined content items extracted from a web-resource based on a condition, the condition included in a web-resource micro-app package operable by a companion manager configured to execute on the primary computing device, the web-resource micro-app package being cross-platform and thus operable, without modification, with any of a plurality of different operating systems with which the companion manager and primary computing device might be associated;
responsive to the condition being met by the predetermined content items, retrieving from the web-resource micro-app package a user notification to be issued by the companion computing device;
formatting the predetermined content items for presentation on the companion computing device based at least on a conditional presentation parameter; and
exporting the formatted predetermined content items to the companion computing device along with an indication to the companion computing device to issue the user notification.

19. The method of claim 18, wherein the predetermined content items are extracted from a web-resource at a cloud service for the companion computing device, and wherein the cloud service exports the extracted predetermined content items to the primary computing device via an operating system push service for an operating system executing on the primary computing device.

20. The method of claim 18, further comprising:
responsive to the condition being met by the predetermined content items, retrieving any conditional icons associated with the conditions; and
formatting the predetermined content items and conditional icons for presentation on the companion computing device.
